(19) United States
(12) Patent Application Publication
(10) Pub. No.: US 2006/0233066 A1
(43) Pub. Date: Oct. 19, 2006

(54) Disk recording apparatus, method, and recording control program

(75) Inventor: Nobuhiko Ando, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/386,969

(22) Filed: Mar. 22, 2006

(30) Foreign Application Priority Data
Mar. 24, 2005 (JP) 2005-086547

(51) Int. Cl. G11B 7/00

(52) U.S. Cl. 369/44.11

(57) ABSTRACT

An optical disk recording apparatus includes a beam emitting unit operable to emit a first beam for irradiating a track on an optical disk so as to record data and second and third beams for irradiating spaces between the track and tracks on both sides of the track, respectively; a light detection mechanism operable to detect the first to third beams reflected from the optical disk; a tracking controller operable to control tracking of the first beam on the basis of results of the reflected first to third beams detected by the light detection mechanism; and a determination unit operable to determine whether the first beam records data on a white portion of the track or overwrites data on a recorded portion of the track based on changes in reflected light amounts of the second and third beams detected by the light detection mechanism.

### CROSS-REFERENCE TO RELATED APPLICATIONS

The present application claims priority from Japanese Patent Application No. JP 2005-086547 filed on Mar. 24, 2005, the disclosure of which is hereby incorporated by reference herein.

### BACKGROUND OF THE INVENTION

The present invention relates to a disk recording apparatus, a recording method, and a recording control program suitable for use in recording data by tracking control of an optical disk having multiple recording layers using a DPP (differential push-pull) system.

Recently, recordable optical disks have been generally used as recording media for recording digital data. For example, in standards of CDs (compact disc) and DVDs (digital versatile disc), recordable optical disks are defined. In particular, the recordable DVD can store high-capacity data, so that it has been significantly in wide spread use as a recording medium replaceable from a conventional magnetic tape. Also, a recordable DVD with two recording layers capable of recording much higher capacity data has appeared.

In a one side two-layered disk having two recording layers on one side, the two recording layers are respectively referred to as an L0 layer and an L1 layer from the incident side of laser light in that order. For example, in “DVD+R” standard, the L0 layer is accessed toward the outer periphery of the disk from the inner periphery in the same way as in a single layered disk while the L1 layer is accessed toward the inner periphery of the disk from the outer periphery. Thereby, the L1 layer can be easily accessed continuously from the L0 layer.

In recordable DVDs, there are a write once DVD and a rewritable DVD rewritable data recorded before. The rewritable DVD will be described below unless otherwise specified. Rewritable DVD standards include a DVD-RW standard, a DVD+RW standard, and a DVD-RAM (random access memory) standard. The DVD-RW standard and the DVD+RW standard will be described below.

In such a rewritable optical disk, a tracking error signal is detected so as to take tracking using a groove provided in the disk, and pits are formed on the groove by a laser beam emitted from an optical pick-up so that data are recorded by forming a track with a pit train.

In the rewritable optical disk complying with DVD-RW standards and DVD+RW standards, the tracking error signal may be detected by a DPP (differential push-pull) system. A tracking control technique by the DPP system is disclosed in Japanese Unexamined Patent Application Publication No. 2005-25790.

In the DPP system, a laser beam emitted from a laser diode is divided into a zero-order beam (main beam) and two first-order beams (side beams) using a diffraction grating. The three divided beams are arranged such that when the main beam is positioned on the groove, the two side beams are located on lands on both sides, respectively. The reflected beams from the respective beams of the optical disk are detected by a split-half light detector, respectively, so as to have a push-pull signal, and then, a tracking error signal DPP is obtained by the computation using equation (1). According to the DPP system, a satisfactory tracking error signal DPP can be obtained without being affected by the visual field deviation in an object lens of the optical pick-up.
DPP=mpp−G×(spp₁+spp₂) (1)
mpp: push-pull signal of the main beam
spp₁, spp₂: push-pull signals of the two side beams
G: a gain defined by the light quantity of the side beam and the gain of a photo-detector (DPP gain)

The push-pull signal is the difference between detected signals of the split-half light-receiving surfaces of the split-half light detector. A tracking servo moves the beams so as to be PD1=PD2 for tracking. That is, the tracking servo moves the beams so as to be the tracking error signal DPP=zero in the above equation (1).

FIG. 20 shows an example of the arrangement of the main beam and the two side beams on an optical disk 100 according to the DPP system. Referring to FIG. 20, the rotation direction of the optical disk 100 is assumed to be clockwise, and the optical disk 100 is provided with grooves 101, 101, . . . formed roughly concentrically about the disk center in advance. Between the grooves 101 and 101, a land 102 is formed. The grooves 101, 101, . . . meander slightly in fact; however, they are shown by straight lines in FIG. 20.

Two side beams 103A and 103B are arranged in front and in rear of a main beam 104 in the rotation direction of the optical disk 100, respectively. In general, the side beam 103A, which is positioned in front of the main beam 104 in the rotation direction, is arranged in the outer radial side than the main beam 104, while the side beam 103B, which is positioned in rear of the main beam 104 in the rotation direction, is arranged in the inner radial side than the main beam 104. Hence, when recording from the inner radial side of the disk toward the outer radial side, the side beam 103A precedes the main beam 104 while the side beam 103B succeeds the main beam 104.

When data is recorded on a white area of the optical disk 100, a track, through which the main beam 104 has passed, is the recorded track already having a pit formed thereon while a track preceding the main beam 104 is a white track having no pit yet. The white track generally has a reflectance of laser light higher than that of the recorded track.

Accordingly, as shown in FIG. 21, in the side beam 103A for example, if one side track of the beam is a white track and the other side track is a recorded track, even when the main beam 104 is positioned at the center of the track, the respective photo-acceptance amounts due to the side beam 103A on the split-half light-receiving surfaces of the split-half light detector differ from each other. In the state of FIG. 21, the photo-acceptance amount PD₁ on the split-half light-receiving surface on the white track side of the split-half light detector is larger than that on the split-half light-receiving surface PD₂ on the recorded track side. As a result, the push-pull signal output from the split-half light detector has an offset.

As described above, the tracking servo moves the beams so that the difference between detected signals due to the split-half light-receiving surfaces PD1 and PD2 of the split-half light detector becomes zero. Thus, in the example of FIG. 21, the tracking servo is operated so that the beam is moved toward the recorded track. As a result, the main beam deviates from the track so as to be de-tracking. The de-tracking is designated that although the main beam can trace the track, it deviates from the track center.

The recording on the white track is referred to as a DOW (Direct Over Write) 0 while the recording on the recorded track is referred to as a DOW1.

When the side beam 103A, which is positioned in front of the main beam 104 in the rotation direction of the disk, is arranged in the outer radial side than the main beam 104, a case where the L0 layer of a single-layered disk or the one side two-layered disk is recorded will be considered. In this case, the recording is executed from the inner radial side of the optical disk 100 toward the outer radial side. When recording on the white track (DOW0 state), as shown in FIG. 22A, tracks on both sides of the side beam 103A are white while tracks on both sides of the side beam 103B are already recorded. Since the respective both sides of the side beam 103A and the side beam 103B are in the same states, the difference between photo-acceptance amounts of the split-half light-receiving surfaces of the split-half light detector is small so that push-pull signals spp1 and spp2 of the side beam 103A and the side beam 103B have no offset. Accordingly, when the beam is moved so as to be the tracking error signal DPP=zero, the main beam may not be detracked.

Similarly, when the L0 layer of the single-layered disk or the one side two-layered disk is recorded, in the state that the recorded track is overwritten (DOW1 state), as shown in FIG. 22B, both tracks on both sides of the side beam 103A and tracks on both sides of the side beam 103B are already recorded. In this case also, in the same way as that described above, the push-pull signals spp1 and spp2 of the side beam 103A and the side beam 103B have no offset, so that the main beam may not be detracked.

Then, when the side beam 103A is arranged in the outer radial side than the main beam 104, a case where the L1 layer of the one side two-layered disk is recorded will be considered. In this case, the recording is executed from the outer radial side of the optical disk 100 toward the inner radial side. When recording on the white track, as shown in FIG. 23A, in both the side beam 103A and the side beam 103B, the inner radial side of the disk is the white track while the outer radial side is the recorded track. Thus, the difference between photo-acceptance amounts of the split-half light-receiving surfaces of the split-half light detector is large in the side beam 103A and the side beam 103B, so that push-pull signals spp₁ and spp₂ have offsets. As a result, the main beam is detracked in the white track direction, i.e., in the outer radial direction of the disk.

On the other hand, in the state that the recorded track is overwritten when the L1 layer of the one side two-layered disk is recorded, as shown in FIG. 23B, both sides of the side beam 103A and the side beam 103B are recorded tracks. In this case also, in the same way as that described above, the push-pull signals spp₁ and spp₂ of the side beam 103A and the side beam 103B have no offset, so that the main beam may not be detracked.

In such a manner, in the past system for obtaining the tracking error signal with the DPP system, when the L1 layer of the one side two-layered disk is recorded, the state that the white track is recorded (DOW0 state) other than the state the recorded track is overwritten (DOW1 state) leads to the detracking. This fact has not been reported as well as solving means therefore is not obviously reported.

FIG. 24 shows example measured results of a detracking amount when the white track of the rewritable DVD is recorded. In FIG. 24, the relationship between the detracking amount (nm) and the jitter (%) during reproducing is shown for when recording from inner radial side of the disk toward the outer radial side (designated by symbol ♦ in the drawing) and for when recording from outer radial side of the disk toward the inner radial side (designated by symbol ▪ in the drawing). Desirable characteristics include that the most satisfactory reproducing signal (the jitter is small) is obtained when the detracking amount is zero, as shown in measured results when recording from the inner radial side toward the outer radial side. Whereas, when recording from the outer radial side toward the inner radial side, if the main beam is detracked rather in the outer radial direction, the jitter becomes smaller, obtaining favorable reproducing signals.

In order to correct the detracking in such a way, under conditions in that the detracking may occur, an offset may be electrically applied to the tracking error signal. In this method, as described above, when the L1 layer of the one side two-layered disk is recorded, the detracking occurrence depends on the kind of the track to be recorded, whether it is white or recorded before. Accordingly, it needs to determine whether the track being recorded at present is white or recorded before.

However, in the past, there was no method for determining whether the track being recorded at present is white or recorded before, i.e., whether the present recording is in the DOW0 state or the DOW1 state.

It is possible to know part of the recorded track and part of the white track in advance on the basis of address information. However, the accuracy in reading address during recording is generally not so high, so that it is difficult to precisely detect the boundary between the recorded track and the white track using the address information. Moreover, there exits a system not reading address during recording.

### SUMMARY OF THE INVENTION

Thus, according to the present invention, it is desirable to provide a disk recording apparatus, a method, and a recording control program capable of determining whether a track being recorded at present is white or recorded before when data are recorded on an optical disk by tracking control using a DPP system.

According to an embodiment of the present invention, there is provided an optical disk recording apparatus including beam emitting means for emitting a first beam for irradiating a track on an optical disk so as to record data and second and third beams for irradiating spaces between the track and tracks on both sides of the track, respectively; light detecting means for detecting the first to third beams reflected from the optical disk; tracking controlling means for controlling tracking of the first beam on the basis of results of the reflected first to third beams detected by the light detecting means; and determining means for determining whether the first beam records data on a white portion of the track or overwrites data on a recorded portion of the track based on changes in reflected light amounts of the second and third beams detected by the light detecting means.

According to an embodiment of the present invention, there is provided an optical disk recording method including emitting a first beam for irradiating a track on an optical disk so as to record data and second and third beams for irradiating spaces between the track and tracks on both sides of the track, respectively; detecting the first to third beams reflected from the optical disk; controlling tracking of the first beam based on the reflected first to third beams; and determining whether the first beam records data on a white portion of the track or overwrites data on a recorded portion of the track based on changes in reflected light amounts of the second and third beams.

According to an embodiment of the present invention, there is provided a recording control program for allowing a computer to execute an optical disk recording method, the optical disk recording method including emitting a first beam for irradiating a track on an optical disk so as to record data and second and third beams for irradiating spaces between the track and tracks on both sides of the track, respectively; detecting the first to third beams reflected from the optical disk; controlling tracking of the first beam based on the reflected first to third beams; and determining whether the first beam records data on a white portion of the track or overwrites data on a recorded portion of the track based on changes in reflected light amounts of the second and third beams.

As described above, according to an embodiment of the present invention, on the basis of changes in reflected light amounts of the second and third beams irradiating spaces between a track and tracks on both sides of the track, respectively, for tracking control of the first beam irradiating the track on the optical disk so as to record data, it is determined whether the first beam records on a white portion of the track or overwrites on the recorded portion. Hence, the transition from the overwriting on the recorded portion of the track to the recording on the white portion can be detected during the recording. Thereby, suitable recording control can be performed on the overwriting on the recorded portion and the recording on the white portion, and also pre-existing hardware structures can be used as they are.

According to an embodiment of the present invention, when recording on a rewritable optical disk by tracking control with the DPP system, based on the sum of the reflected light amounts of the two side beams, it is determined whether the present recording is in DOW0 state or in DOW1 state. Therefore, the detracking generated when the recording state is changed from DOW1 state to DOW0 state during recording for the outer radial side of the disk toward the inner radial side can be effectively prevented.

Also, the detracking generated when recording on an L1 layer of the two-layered disk can thereby be prevented.

Furthermore, according to an embodiment of the present invention, since it can be precisely determined whether the present recording is in DOW0 state or in DOW1 state, as described above, the optimum recording conditions (such as recording power, a strategy, and servo setting) can be established for the recording in DOW0 state and the recording in DOW1 state, respectively. Also, there is an advantage of improved quality of recording signals.

### BRIEF DESCRIPTION OF THE DRAWINGS

FIG. 1 is a block diagram of an example of an optical disk drive according to an embodiment of the present invention;

FIG. 2 is a conceptual schematic diagram of an example of a light path in an optical pick-up;

FIG. 3 is a schematic diagram of a structural example of a recording layer of an optical disk;

FIGS. 4A and 4B are schematic diagrams showing a disk layout of the optical disk complying with rewritable DVD standards;

FIG. 5 is a schematic diagram showing an arrangement of a main beam and two side beams on the optical disk;

FIG. 6 is a schematic diagram of a structural example of a photo-detector;

FIG. 7 is a schematic diagram showing measured results of light receiving amounts in the photo-detector when conditions of tracks on both sides of the side beam are changed;

FIGS. 8A to 8D are schematic diagrams showing situations of the main beam and two side beams irradiating the optical disk;

FIG. 9 is a schematic diagram showing changes in reflected light amount of the side beam when recording from the inner radial side of the disk toward the outer radial side;

FIGS. 10A to 10D are schematic diagrams showing situations of the main beam and two side beams irradiating the optical disk;

FIG. 11 is a schematic diagram showing changes in reflected light amount of the side beam when recording from the outer radial side of the disk toward the inner radial side;

FIGS. 12A and 12B are schematic diagrams showing changes in sum of reflected light amounts of the two side beams;

FIG. 13 is a schematic diagram showing the relationship among levels SPD0 to SPD4;

FIG. 14 is a flowchart showing a setting method of a threshold value SPDₜₕ;

FIGS. 15A to 15D are schematic diagrams showing situations of the main beam and two side beams irradiating the optical disk;

FIG. 16 is a schematic diagram showing changes in reflected light amount of the side beam when recording from the inner radial side of the disk toward the outer radial side;

FIGS. 17A to 17D are schematic diagrams showing situations of the main beam and two side beams irradiating the optical disk;

FIG. 18 is a schematic diagram showing changes in reflected light amount of the side beam when recording from the outer radial side of the disk toward the inner radial side;

FIGS. 19A and 19B are schematic diagrams showing changes in sum of reflected light amounts of the two side beams;

FIG. 20 is a schematic diagram showing an arrangement of a main beam and two side beams on the optical disk with a DPP system;

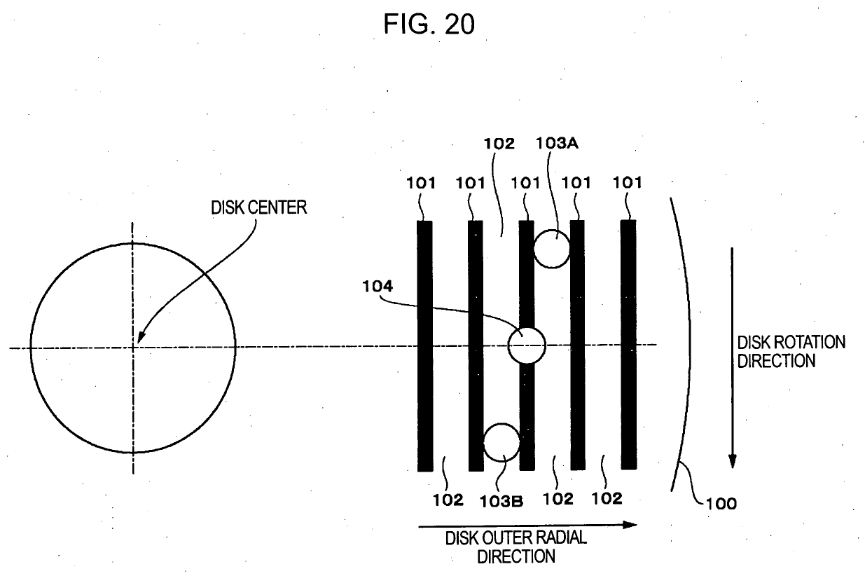

FIG. 21 is a schematic diagram for illustrating that when one side of the side beam is a white track and the other side is a recorded track, a difference is generated between light receiving amounts on the respective two-divided light receiving surfaces of a two-split photo-detector;

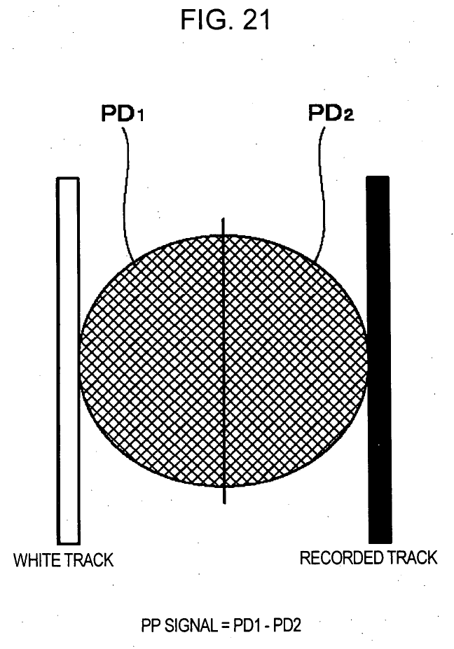

FIGS. 22A and 22B are schematic diagrams showing the relationship between the recording tracks, the main beam, and the two side beams;

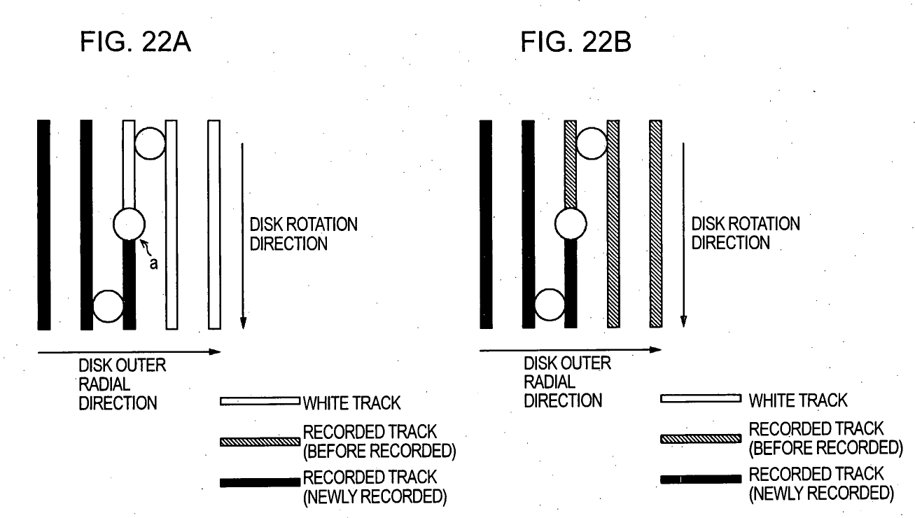

FIGS. 23A and 23B are schematic diagrams showing the relationship between the recording tracks, the main beam, and the two side beams; and

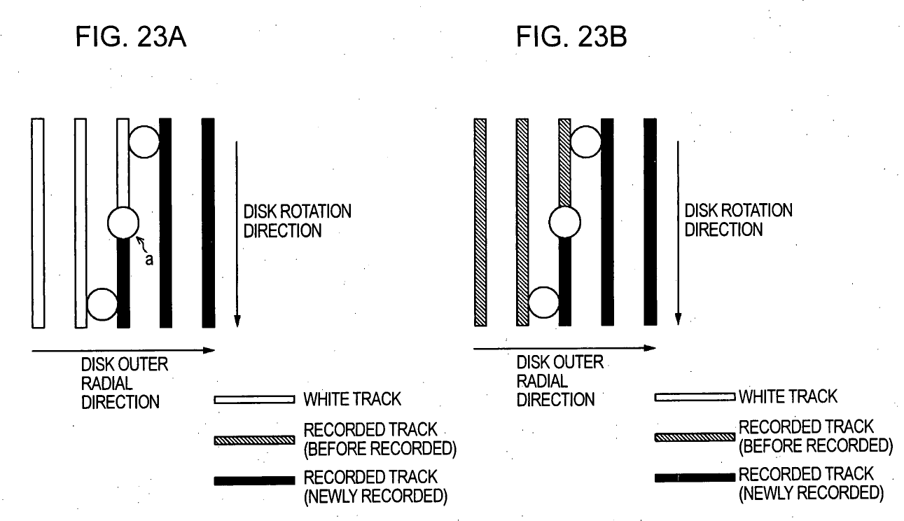

FIG. 24 is a graph showing measured results of detracking amounts when recording on a white track of a recordable DVD.

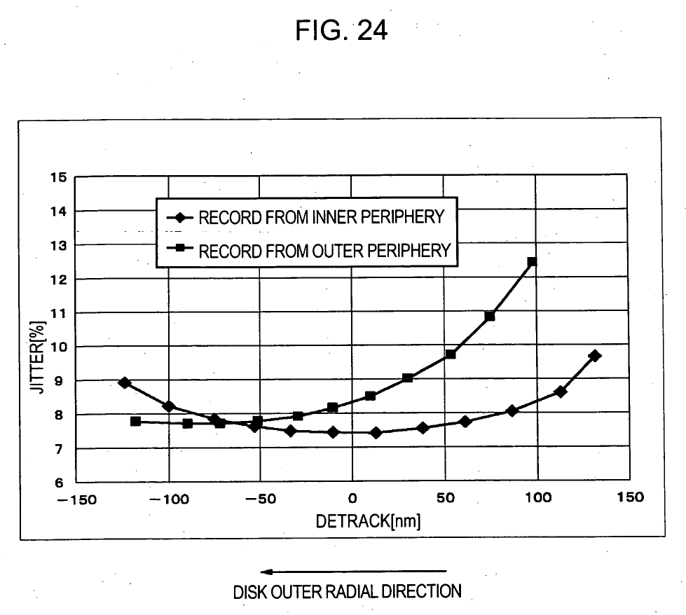

### DETAILED DESCRIPTION

Embodiments according to the present invention will be described below with reference to the drawings. According to the present invention, when data are recorded on a rewritable optical disk by tracking control using a DPP (differential push-pull) system, in a configuration that in two side beams by the DPP system, the side beam positioned in front of a main beam in the rotation direction of the disk is arranged in the outer radial side of the disk than the main beam, a track being recorded at present is determined whether white or recorded before on the basis of change in light amount of the side beam.

According to the present invention, a tracking offset can be prevented, which is generated when recording on a white track from the outer radial side of the disk toward the inner radial side, such as recording on the L1 layer of a rewritable one side two-layered disk.

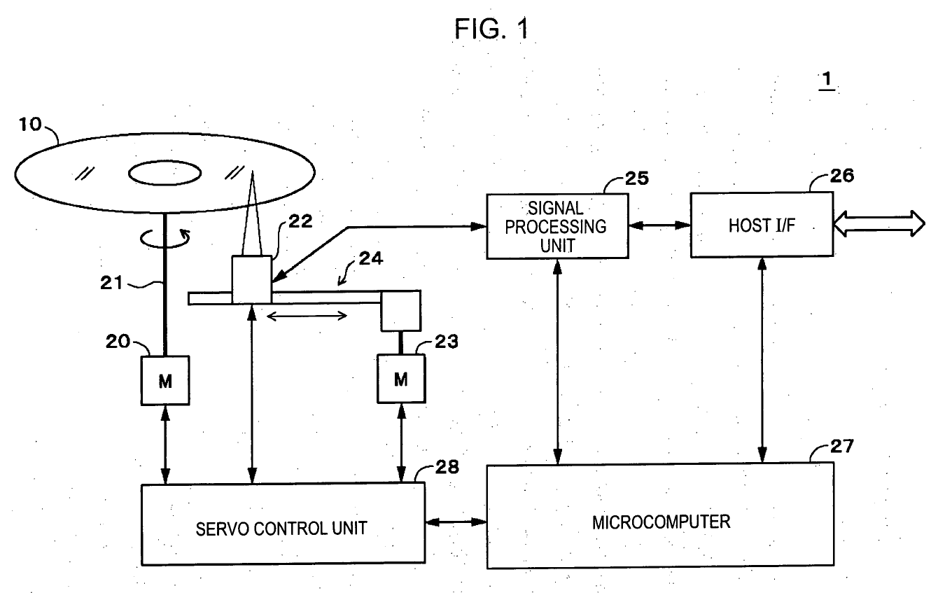

FIG. 1 shows a configuration of an optical disk drive 1 according to an embodiment of the present invention. An optical disk 10 is brought into engagement with a shaft 21 of a spindle motor 20 with a cramp mechanism (not shown) rotatably by being driven by the spindle motor 20.

An optical pick-up 22 is arranged at a position opposing the recording surface of the optical disk 10. The optical pick-up 22 is placed on a thread 24, which is movable in the radial direction of the optical disk 10 by a thread motor 23, so as to move in the radial direction of the optical disk 10 together with the thread 24.

The optical pick-up 22 includes a laser light source, a beam splitter, a grating, a photo-detector, and an object lens. A laser beam emitted from the laser light source is divided into three components that are a main beam and two side beams, and enters the object lens after passing through the beam splitter. The object lens irradiates the incident main beam and the two side beams on the recording surface of the optical disk 10. The laser beam is reflected on the recording surface of the optical disk 10 and then, is entered in the beam splitter via the object lens so as to arrive at the photo-detector by being reflected at the beam splitter. The photo-detector takes out respective push-pull signals of the main beam and the two side beams for outputting.

The output of the optical pick-up 22 is supplied to a signal processing unit 25. The signal processing unit 25 produces a focus error signal, a tracking error signal, etc., on the basis of the output of the optical pick-up 22 so as to feed them to a microcomputer 27. The microcomputer 27 supplies control signals to a servo control unit 28 on the basis of these focus error signal and tracking error signal. The servo control unit 28 performs various servo controls, such as spindle servo, thread servo, servo for the object lens (focus servo and tracking servo), on the basis of supplied control signals.

During recording, the signal processing unit 25 performs error-correction encoding processing and record encoding processing on recording data supplied via a host interface (I/F), and further it performs predetermined signal processing, such as modulation processing, thereon so as to produce a recording signal. The recording signal is fed to the optical pick-up 22 so as to modulate the laser beam. During reproducing, predetermined processing, such as RF signal processing, binarization processing, PLL (phase locked loop) synchronous processing, and decryption processing of recording codes, is performed on the signal output from the optical pick-up 22 so as to take out digital data. The digital data output from the signal processing unit 25 are fed to an external device via the host I/F 26.

Furthermore, during recording, recording instructions are given via the host I/F 26 so as to feed them to the microcomputer 27. The microcomputer 27 instructs the servo control unit 28 to start recording on the basis of the recording instructions. The servo control unit 28 controls the position of the optical pick-up 22 on the basis of the instructions from the microcomputer 27. Also, the microcomputer 27 establishes various recording conditions, such as a write strategy, recording power, and a defocus amount, for the signal processing unit 25. According to the established recording conditions, the signal processing unit 25 controls the modulation of the recording signal and the laser light source drive. During reproducing, the signal processing unit 25 and the servo control unit 28 are also controlled by the microcomputer 27 in the same way.

The microcomputer 27 is composed of a microprocessor for example, and on the basis of programs stored in an ROM (read only memory) (not shown) in advance, it controls the operation of the optical disk drive 1 as described above. When the ROM is replaced by a rewritable memory such as an EEPROM (electrically erasable programmable read only memory), the stored programs can be desirably updated. The program data to be updated are supplied from the host I/F 26.

As will be described later in detail, during recording, the microcomputer 27 detects the state of a recording part on the basis of the output of the optical pick-up 22 so as to be able to establish the recording conditions corresponding to the detected state for the servo control unit 28.

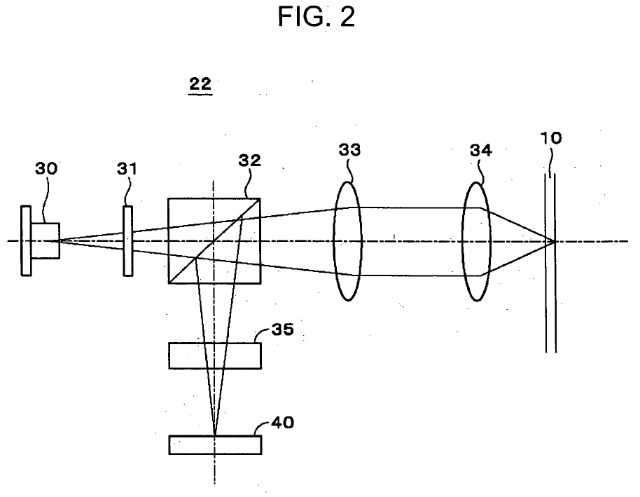

FIG. 2 conceptually shows a light path in the optical pick-up 22. Laser light emitted from a laser light source 30 made of a laser diode is divided into a zero-order main beam and two first-order side beams by a grating 31, and enters a collimator lens 33 via a beam splitter 32. The laser light is converted into parallel rays by the collimator lens 33, and converged by an object lens 34 so as to irradiate the recording surface of the optical disk 10. The laser light is reflected on the recording surface of the optical disk 10, and is incident in the beam splitter 32 via the object lens 34 and the collimator lens 33. The reflected laser light is reflected by the beam splitter 32 in a predetermined manner and incident in a photo-detector 40 via a cylindrical lens 35.

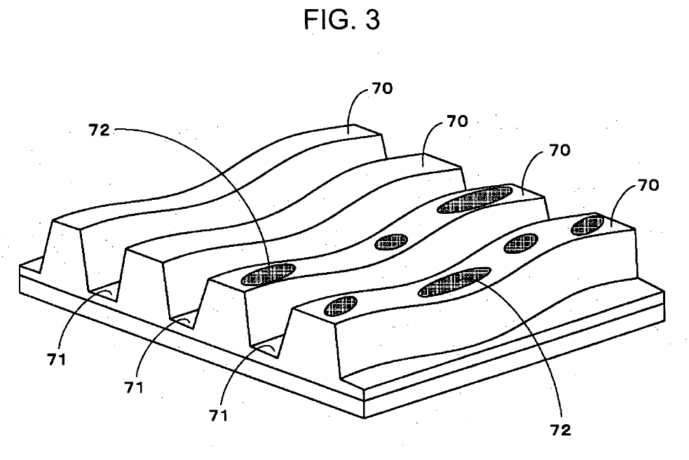

FIG. 3 schematically shows the structure of a recording layer of the optical disk 10. On the recording layer, grooves 70, 70, . . . wobbled at a predetermined frequency are formed as guide grooves for introducing laser light to a track. Between the grooves 70 and 70, a land 71 is formed. The address information is indicated by a pre-pit (not shown) formed on the land 71 in the DVD-RW standard, and is indicated by a high-frequency (not shown) superposed on a wobble in the DVD+RW standard.

Data is recorded by forming a record mark 72 on the groove 70 with the laser light introduced to the track. In a rewritable optical disk conforming with the DVD-RW standard and the DVD+RW standard, the recording layer is made of a phase change film, and the forming the record mark 72 and the erasing the formed record mark 72 can be executed using the reversible change between the crystalline substance and the non-crystalline substance of the phase change film. By changing the emission intensity of the laser light in a predetermined manner, changes in the phase change film are controlled. A new record mark 72 is formed directly after the record mark 72 is erased thereon, so that data can be overwritten thereon.

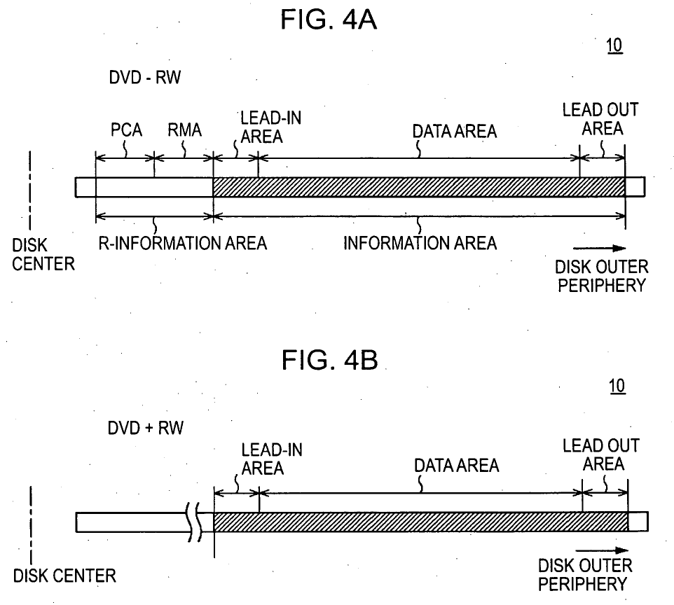

FIGS. 4A and 4B are schematic layouts of the optical disk 10 conforming to a rewritable DVD standard. According to the DVD-RW standard, as schematically shown in FIG. 4A, in the most inside periphery of the disk, a recording information management area (R-information area) is provided and a data area (information area) is provided outside the R-information area for use in recording user data. In the R-information area, a PCA (power calibration area) and an RMA (recording management area) are provided. The PCA is used by the optical disk drive 1 for testing the optimization of the laser power during recording. In the RMA, power calibration information, a recorder ID, and a recording history are recorded. The RMA of the white optical disk 10 has no signal recorded thereon.

The information area is composed of a lead-in area, a data area, and a lead-out area, in that order from the inside periphery. In the lead-in area, pieces of information about the optical disk 10, such as a format version, a disk type (such as DVD-R, DVD+R, DVD-RW, and DVD+RW), and the number of initiation/completion sectors, are recorded.

FIG. 4B schematically shows the disk layout conforming to the DVD+RW standard. In the DVD+RW standard, the R-information area is not provided as in the DVD-RW standard. In the lead-in area, the information about the optical disk 10 is recorded in the same way in the DVD-RW standard.

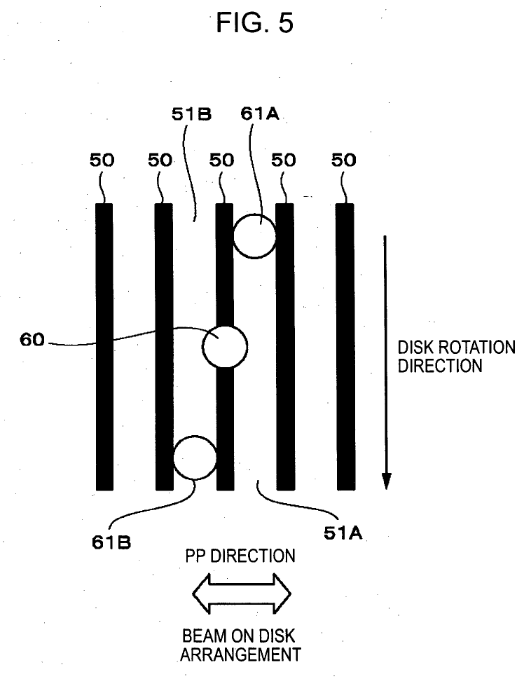

As described above, the laser light emitted from the laser light source 30 is divided into the main beam and the two side beams by the grating 31 so as to irradiate the optical disk 10. FIG. 5 schematically shows the arrangement of the three beams on the optical disk 10. The crosswise direction of the drawing indicates the radial direction of the optical disk 10. The left of FIG. 5 is assumed to be the inside periphery of the optical disk 10 and the right the outside. In FIG. 5, the wobble of grooves 50 is omitted.

A main beam 60 is for recording/reproducing data in practice, and the position of an optical spot of the main beam 60 is controlled so as to irradiate the track 50. On the other hand, side beams 61A and 61B are arranged so that optical spots thereof irradiate lands on both sides of the main beam 60, respectively. For example, when the center of the track 50 is irradiated by the optical spot of the main beam 60, the side beams 61A and 61B are arranged so that optical spots thereof irradiate respective centers of spaces 51A and 51B between the track 50 and tracks on both sides of the track 50.

The side beams 61A and 61B are displaced to the main beam 60 in front and rear in the rotation direction of the optical disk 10. According to the embodiment, when the rotation direction of the optical disk 10 is assumed to be clockwise in FIG. 5, the side beam 61A precedes the main beam 60 while the side beam 61B succeeds the main beam 60.

In order to avoid some complexity, an optical spot by a laser beam is simply referred to a beam bellow. That is, “the main beam 60” and “the side beams 61A and 61B” indicate optical spots by the main beam 60 and the side beams 61A and 61B below, respectively, unless otherwise specified.

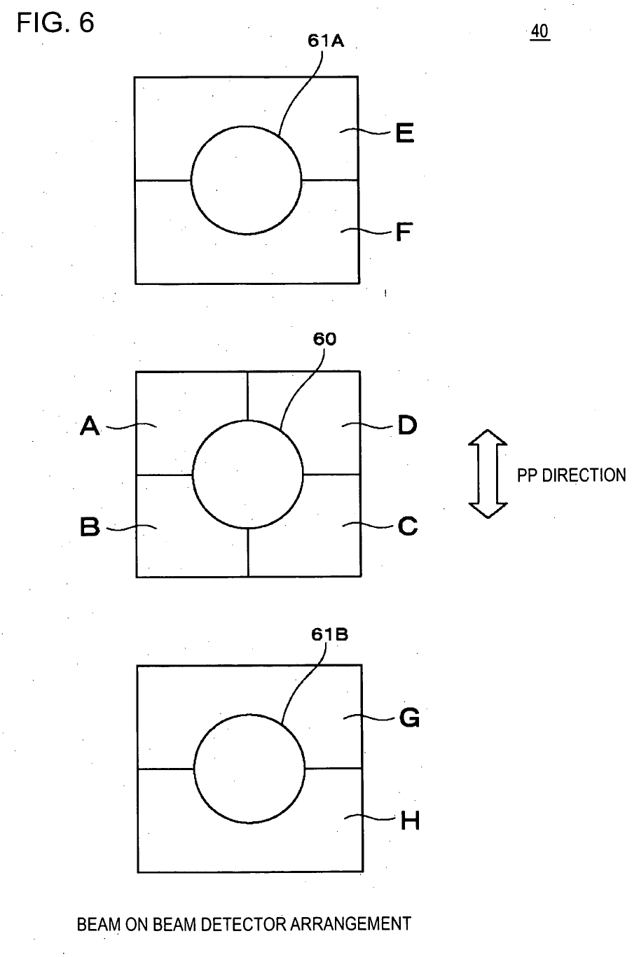

FIG. 6 schematically shows the structural example of the photo-detector 40. The photo-detector 40 has a four-piece shape in the center having four-divided components A to D, and two-piece shapes on both sides having half-divided components E and F and half-divided components G and H. The four-divided components A to D receive the reflected main beam 60 so as to obtain a push-pull signal mpp from the difference between light-receiving amounts by the elements A and D and the elements B and C. The half-divided components E and F receive the reflected side beam 61A, for example, to obtain a push-pull signal spp1 from the difference between light-receiving amounts by the elements E and F. Similarly, the half-divided components G and H receive the reflected side beam 61B, for example, to obtain a push-pull signal spp2 from the difference between light-receiving amounts by the elements G and H.

Referring to FIG. 5 described above, each push-pull signal is obtained from signals divided in the radial direction of the optical disk 10. The reflected beams of the beams 60, 61A, and 61B arranged as shown in FIG. 5 are condensed in a line by the cylindrical lens 35 so as to irradiate the photo-detector 40 as shown in FIG. 6. In the example of FIGS. 5 and 6, the half-divided elements E and G and the half-divided elements A and D of the photo-detector 40 correspond to the outer radial side of the optical disk 10. The half-divided elements F and H and the half-divided elements B and C of the photo-detector 40 correspond to the inner radial side of the optical disk 10.

The tracking error signal DPP is obtained from the following equation (2) when output signals from the components A to H are referred to characters A to H, respectively.
DPP=(A+D)−(B+C)−α×{(E−F)+(G−H)} (2)
where factor α is a DPP gain determined by the light amount of the side beam and the gain of the photo-detector 40.

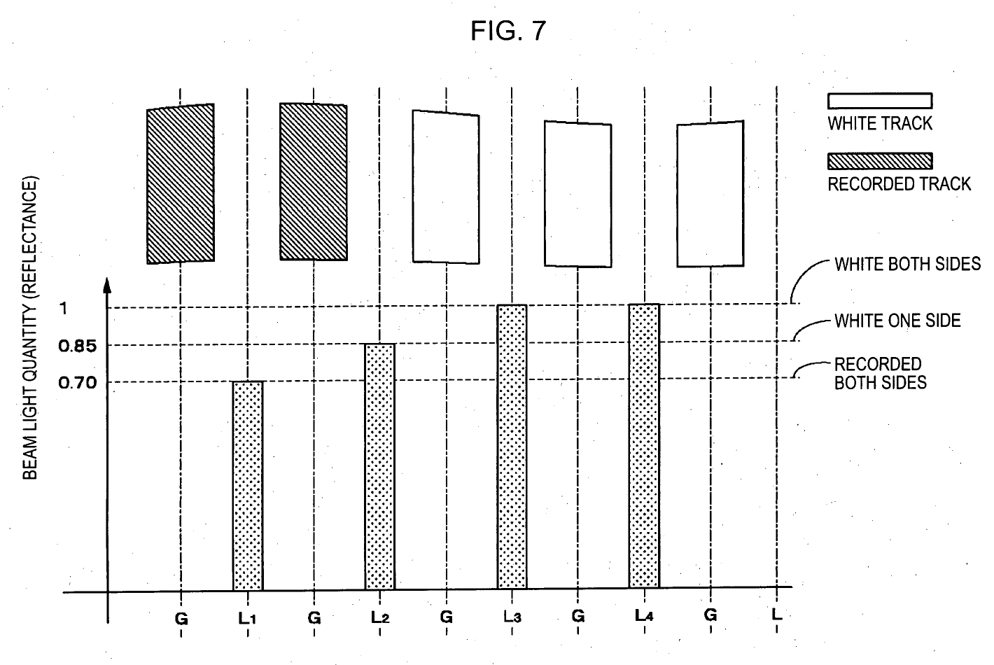

Then, the embodiment of the present invention will be described more in detail. FIG. 7 shows measured light-receiving amounts in the photo-detector when conditions of tracks on both sides of the side beam are changed. That is, in FIG. 7, the abscissa indicates the radial direction of the optical disk 10, in which the first and second tracks from the left are recorded (shown by oblique lines) and subsequent tracks including the third track are white. The side beam sequentially irradiates the land (shown by character L) between tracks, and light amounts reflected from the optical disk 10 are indicated by vertical bars (shown by L₁ to L₄ in convenience sake).

From the example of FIG. 7, it is understood that if the reflected light amount, when tracks on both sides of an optical spot by the side beam are white, is assumed to be “1” (the bars L₃ and L₄), when tracks on both sides of an optical spot by the side beam are both recorded, the reflectance is approximately 0.70 (the bar L₁); and when the tracks are white and recorded combined, the reflectance is approximately 0.85 (the bar L₂). That is, in comparison with the case where tracks on both sides of an optical spot by the side beam are white, the reflected light amount in the state that tracks on both sides are recorded is lower by approximately 30% while the reflected light amount in the state that one side track is only recorded is lower by approximately 15%.

Then, changes in reflected light amount of the side beam during recording will be described. The change in reflected light amount of the side beam is different between cases in recording from the inner side toward the outer side and in recording from the outer side toward the inner side.

In addition, the preceding side beam 61A to the main beam 60 in the rotation direction of the optical disk 10 is referred to as the preceding beam below in convenience sake. Similarly, the succeeding side beam 61B to the main beam 60 in the rotation direction of the optical disk 10 is referred to as the succeeding beam. The preceding side beam 61A is assumed to be arranged in the outer radial side of the disk further than the main beam 60.

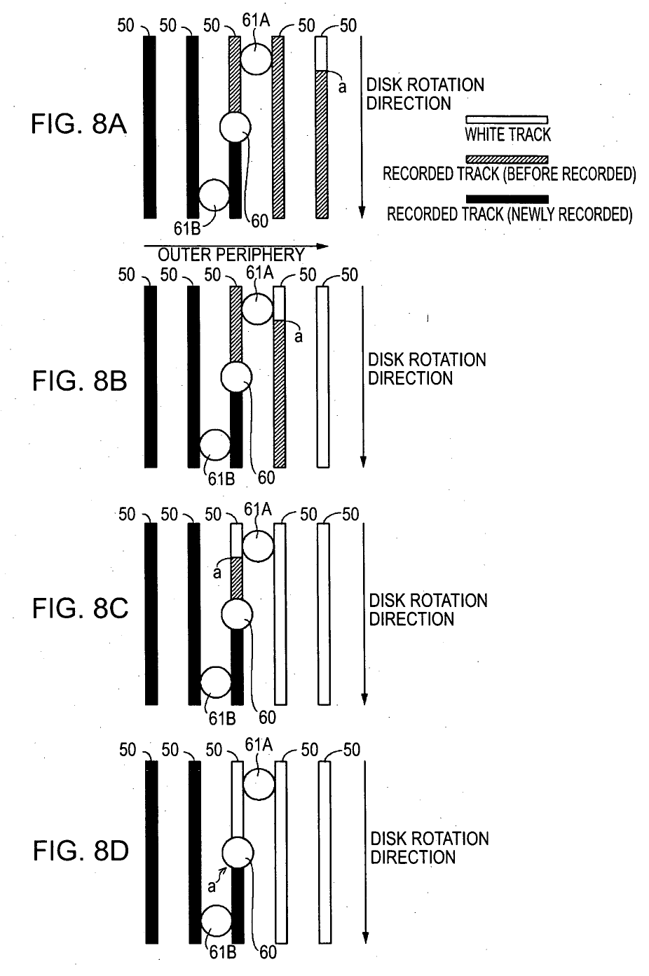

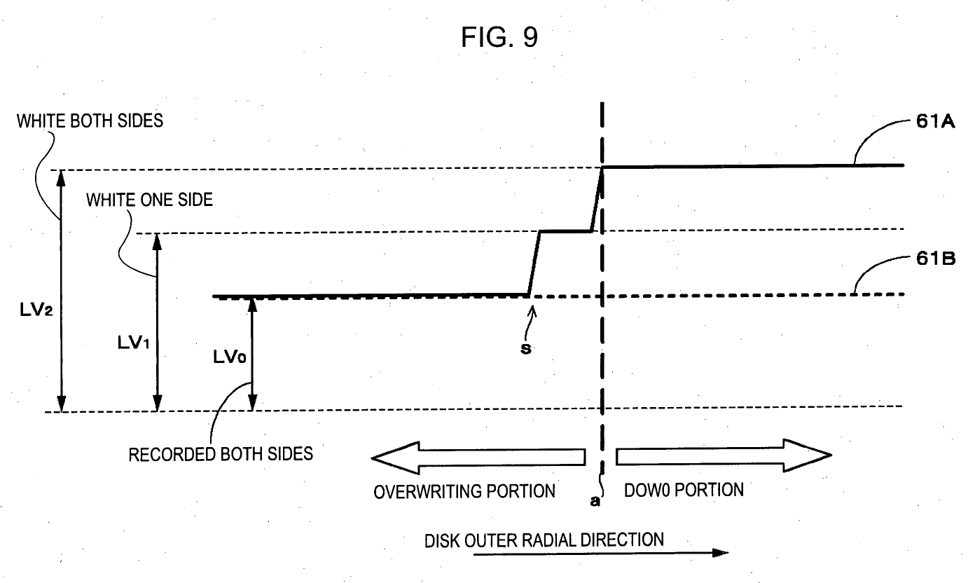

First, with reference to FIGS. 8A to 9, changes in reflected light amounts of the side beams 61A and 61B when recording from the inner radial side toward the outer radial side of the optical disk 10 will be described.

FIGS. 8A to 8D schematically show respective situations in that the optical disk 10 is irradiated with optical spots by the main beam 60 and the side beams 61A and 61B for every one revolution of the optical disk 10. On the optical disk 10 herein from the outer radial side to a boundary position “a”, data is assumed to be already recorded before the present recording. The area from the boundary position “a” to the inner radial side is a white portion of the track. In FIGS. 8A to 8D, the revolution direction of the optical disk 10 is clockwise, and the left of the drawing is the outer radial side of the optical disk 10. In the tracks 50, 50, . . . , portions painted black are newly recorded on white tracks; obliquely lined portions are already recorded before the present recording; and other portions designate white portions. These indications in FIGS. 8A to 8D are common to the similar drawings below.

That is, in FIGS. 8A to 8D, already recorded portions are overwritten (DOW1 state) at first, and then, after the optical spot of the main beam 60 passed the boundary position “a”, the newly recording on white portions starts (DOW0 state).

When recording on the optical disk 10 from the inner radial side toward the outer radial side of the disk, as shown in FIGS. 8A to 8D, the position succeeding the main beam 60 in the rotation direction of the disk and the track is irradiated with the side beam 61B. Hence, portions on both sides of the side beam 61B are typically recorded.

Also, the position preceding the main beam 60 in the rotation direction of the disk and the track is irradiated with the side beam 61A. Hence, as shown in FIG. 8D, when the main beam 60 is white and the present recording is in DOW0 state, portions on both sides of the side beam 61A are typically white.

On the other hand, when the main beam 60 includes portions already recorded before the present recording, these portions are to be in an overwritten state (DOW1 state). In the overwritten state, if the outer radial side of the side beam 61A has already recorded portions, portions on both sides of the side beam 61A are recorded (see FIG. 8A). If the outer radial side of the side beam 61A reaches the white portion beyond the boundary position “a”, the outer radial side of the side beam 61A is white while the inner radial side is recorded (see FIG. 8B). From this state, if the recording progresses by an amount equivalent to one track so that the inner radial side of the side beam 61A reaches the white portion beyond the boundary position “a”, portions on both sides of the side beam 61A are white (see FIG. 8C).

When recording on the optical disk 10 from the inner radial side toward the outer radial side of the disk 10 in such a manner, the reflected light amount of the side beam 61A changes in three steps in accordance with the state of portions on both sides of the side beam 61A.

FIG. 9 shows changes in reflected light amounts of the side beams 61A and 61B when recording on the disk from the inner radial side toward the outer radial side of the disk. The ordinate designates the reflected light amount level while the abscissa indicates time.

As is already described with reference to FIG. 7, the reflected light amounts of the side beams 61A and 61B change stepwise corresponding to the state of portions on both sides of the beam. That is, when portions on both sides are white, the reflected light amount has the highest level (indicated by LV₂ in FIG. 9); when portions on both sides are recorded, it has the lowest level (indicated by LV₀ in FIG. 9); and when one side of the beam is white and the other is recorded, it has the intermediate level (indicated by LV₁ in FIG. 9).

In the state of FIG. 8A at first, the reflected light amount (indicated by the dotted line in FIG. 9) of the preceding side beam 61A is at Level LV₀ in which portions on both sides of the beam are recorded. For example, at a time “s” in FIG. 9, the outer radial side of the side beam 61A reaches the boundary position “a”, so that the outer radial side of the side beam 61A is white while the inner radial side becomes recorded (see FIG. 8B) and the reflected light amount of the side beam 61A is to be at level LV₁. When the recording further progresses so that the inner radial side of the side beam 61A reaches the boundary position “a”, portions on both sides of the side beam 61A are white (see FIG. 8C) and the reflected light amount of the side beam 61A is to be at level LV₂ in which portions on both sides of the beam are white, and this state is maintained thereafter.

Since portions on both sides of the succeeding side beam 61B are typically recorded, the reflected light amount is at level LV₀ in which portions on both sides are typically recorded.

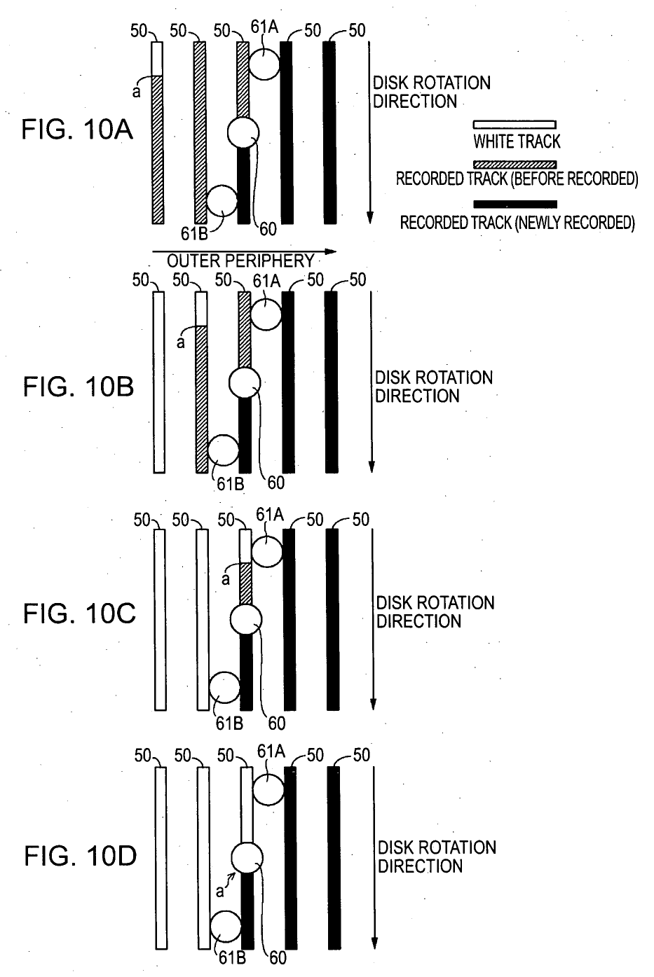

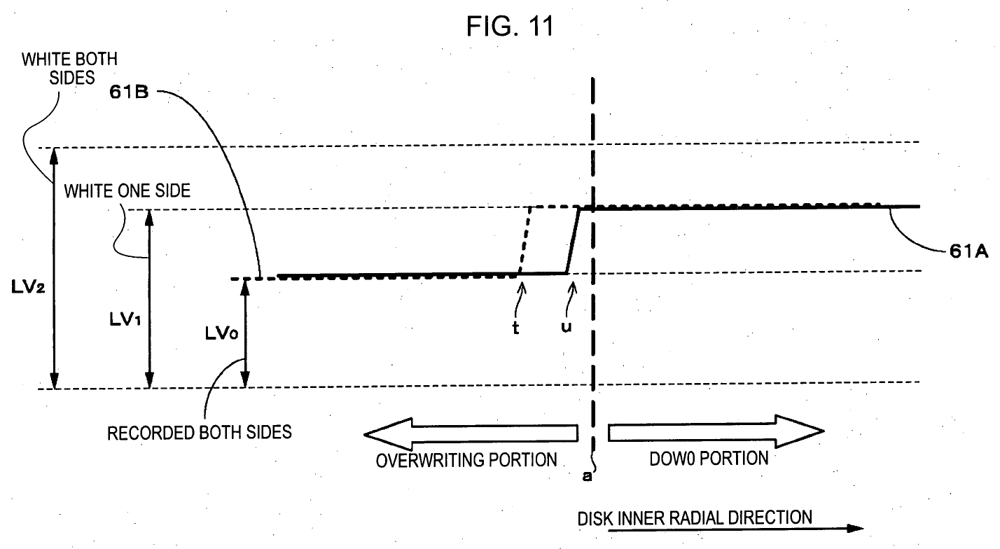

Then, with reference to FIGS. 10A to 11, changes in reflected light amounts of the side beams 61A and 61B when recording from the outer radial side toward the inner radial side of the disk will be described. In addition, designations of portions in FIGS. 10A to 11 are common to those in FIGS. 8A to 9 described above, so that the description thereof is omitted for avoiding complexity.

When recording on the optical disk 10 from the outer radial side toward the inner radial side, the side beam 61B is arranged at a position preceding the main beam 60 in the tracking direction of the disk 10 as well as in the rotation direction of the optical disk 10. On the other hand, the side beam 61A is arranged at a position succeeding the main beam 60 in the tracking direction of the optical disk 10.

When recording on the optical disk 10 from the outer radial side toward the inner radial side, the succeeding position in the tracking direction of the disk 10 is irradiated with the side beam 61A while the preceding position is irradiated with the side beam 61B. Also, the preceding position in the rotation direction of the disk 10 is irradiated with the side beam 61A while the succeeding position is irradiated with the side beam 61B. Hence, as shown in FIGS. 10A to 10D, the outer radial side of the side beams 61A and 61B is typically in a state in that the main beam 60 has passed, so that the outer radial side becomes recorded by the present recording. The state of the inner radial side of the side beams 61A and 61B depends on the fact that whether this portion is already recorded before the present recording or not.

Accordingly, as shown in FIG. 10D, when the main beam 60 includes a white portion and is in state DOW0, the outer radial side of the side beams 61A and 61B is recorded while the inner radial side is white, differently from the example shown in FIG. 8D.

FIG. 11 shows changes in reflected light amounts of the side beams 61A and 61B when recording on the disk from the outer radial side toward the inner radial side of the disk. In the state of FIG. 10A at first, the reflected light amounts of both the preceding side beam 61B and the succeeding side beam 61A are at Level LV₀ in which portions on both sides of the beam are recorded. When the recording progresses from the state of FIG. 10B, at a time “t” in FIG. 11, for example, the inner radial side of the side beam 61B reaches the boundary position “a” so as to become white. Since the outer radial side of the side beam 61B is typically recorded, the reflected light amount of the side beam 61B is to be at level LV₁. After the inner radial side of the side beam 61B reached the boundary position “a” (see FIGS. 10C and 10D), the reflected light amount of the side beam 61B is maintained at level LV₁.

On the other hand, at a time “u” after an elapsed time equivalent to one track from the time “t”, the inner radial side of the succeeding side beam 61A reaches the boundary position “a” so as to become white (see FIG. 10C). The time from the time “t” to the time “u” is in fact shorter than the time equivalent to one track by a time corresponding to the space between the side beams 61A and 61B. Since the outer radial side of the side beam 61A is typically recorded, the reflected light amount of the side beam 61A is to be at level LV₁. After the inner radial side of the side beam 61A reached the boundary position “a” (see FIG. 10D), the reflected light amount of the side beam 61A is maintained at level LV₁.

As is described with reference to FIGS. 9 and 11, the changes in reflected light amounts of the side beams 61A and 61B are different between cases in recording from the inner side toward the outer side and in recording from the outer side toward the inner side. The sum of the reflected light amounts of the side beams 61A and 61B in both the recording cases is figured out now.

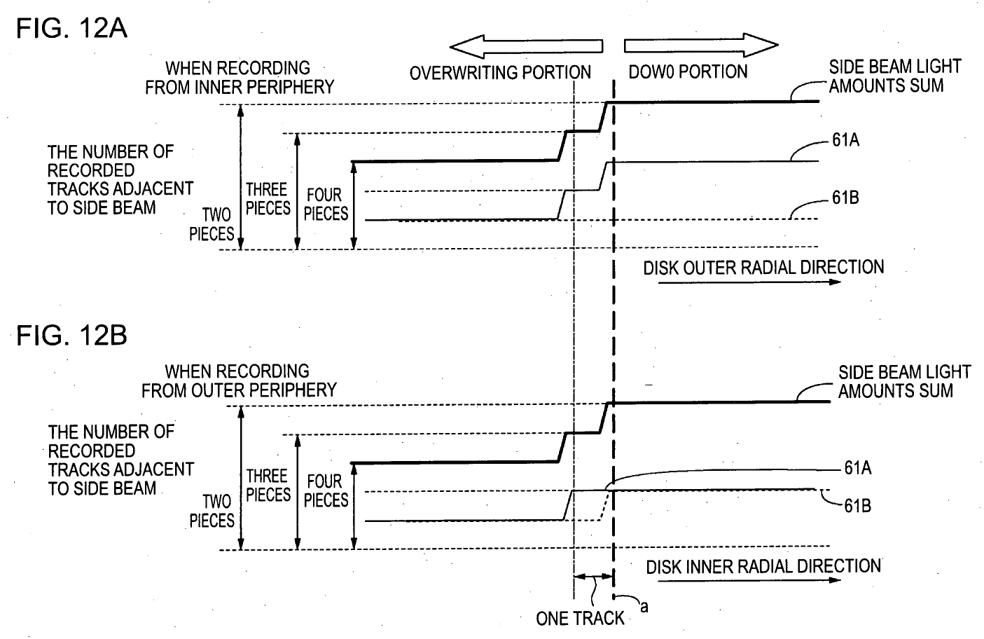

FIGS. 12A and 12B show changes in sum of the reflected light amounts of the side beams 61A and 61B. FIG. 12A shows the example when recording from the inner side toward the outer side while FIG. 12B shows the example when recording from the outer side toward the inner side. In FIGS. 12A and 12B, “preceding beam light amount” schematically designates the reflected light amount by the side beam 61A; “succeeding beam light amount” the reflected light amount by the side beam 61B; and “side beam quantity sum” the sum of the reflected light amounts of the side beams 61A and 61B.

From FIGS. 12A and 12B, it is understood that the sum of the reflected light amounts of the side beams 61A and 61B be changed in a predetermined manner at the boundary position “a”, i.e., in front and rear of DOW0 despite of the radial recording direction of the optical disk 10.

On the basis of the state of tracks adjacent to the side beams 61A and 61B, changes in sum of the reflected light amounts of the side beams 61A and 61B in front and rear of DOW0 will be considered. Two tracks neighbor on one side beam so that the sum of the tracks neighboring to the side beams 61A and 61B is four in maximum.

First, DOW0 state in that the main beam 60 is located in a white portion of a track will be considered.

(1) In DOW0 State when Recording from the Inner Radial Side Toward the Outer Radial Side

As is already described with reference to FIGS. 8A to 9, since the side beam 61A precedes the main beam 60 in the tracking direction and the revolution direction of the disk in this case, portions on both sides are white in DOW0 state. Also, since the side beam 61B succeeds the main beam 60 in the tracking direction and the revolution direction of the disk, portions on both sides are recorded. Hence, the number of the recorded portions (recorded tracks) neighboring to the side beams 61A and 61B is two.

(2) In DOW0 State when Recording from the Outer Radial Side Toward the Inner Radial Side:

As is already described with reference to FIGS. 10A to 11, since the side beam 61A succeeds the main beam 60 in the tracking direction, and it precedes the main beam 60 in the revolution direction of the disk in this case, a portion on the outer radial side is recorded and a portion on the inner radial side is white in DOW0 state. Also, since the side beam 61B precedes the main beam 60 in the tracking direction and succeeds the main beam 60 in the revolution direction of the disk, a portion on the outer radial side is recorded and a portion on the inner radial side is white in DOW0 state. Hence, the number of the recorded portions neighboring to the side beams 61A and 61B is two.

In such a manner, in DOW0 state, the number of the recorded portions neighboring to the side beams 61A and 61B is typically two despite of the recording direction, the side beam 61A, and the main beam 60.

Then, the state in that the main beam 60 is not located in a white portion is considered. In this case, an already recorded portion before the present recording is irradiated with the main beam 60 so as to be overwritten.

(1) When Recording from the Inner Radial Side Toward the Outer Radial Side

As is already described with reference to FIGS. 8A to 9, in this case, the number of the recorded portions neighboring to the side beam 61A depends on the fact that whether the outer side and/or the inner side of the beam have passed through the boundary position “a” between the white portion and the recorded portion, or not, so that the number is to be 0, 1, and 2 in that order from the furthest position of the side beam 61A from the boundary position “a”.

In addition, before DOW0 state, the state that the number of the recorded portions is 0 exists for an extremely short time while the boundary position “a” passes through a predetermined section between the inner side of the side beam 61A and the main beam 60.

Since portions on both sides of the side beam 61B are typically recorded as described above, the number of the recorded portions neighboring to the side beams 61A and 61B is 2.

Hence, the number of the recorded portions neighboring to the side beams 61A and 61B is to be 4, 3, and 2 in that order from the furthest position of the side beam 61A from the boundary position “a”, as shown in FIG. 12A. Before DOW0 state, the state that the number of the recorded portions is 2 exists for an extremely short time while the boundary position “a” passes through from the inner side of the side beam 61A to the main beam 60.

(2) When Recording from the Outer Radial Side Toward the Inner Radial Side

As is already described with reference to FIGS. 10A to 11, since the side beam 61A succeeds the main beam 60 in the tracking direction, and it precedes in the revolution direction of the disk in this case, the outer radial side is typically recorded, and the number of the neighboring recorded portions depends on the fact that whether the inner side has passed through the boundary position “a” to the white portion or not. That is, the number of the recorded portions neighboring to the side beam 61B is to be 2 until the inner side of the side beam 61A passes through the boundary position “a” and to be 1 after it passed through the boundary position “a”, as shown in FIGS. 10A to 10D.

In addition, before DOW0 state, the state that the number of the recorded portions is 1 exists for an extremely short time while the boundary position “a” passes through a predetermined section between the inner side of the side beam 61A and the main beam 60.

On the other hand, since the side beam 61B precedes the main beam 60 in the tracking direction and succeeds the main beam 60 in the revolution direction of the disk, the outer radial side is typically recorded, so that the number of the neighboring recorded portions depends on the fact that whether the inner side has passed through the boundary position “a” to the white portion or not. That is, the number is to be 2 until the side beam 61B passes through the boundary position “a”, and to be 1 after it passed through the boundary position “a”, as shown in FIGS. 10A to 10D.

Accordingly, the number of the recorded portions neighboring to the side beams 61A and 61B is to be 4 until the outer side of the side beam 61B passes through the boundary position “a” as shown in FIG. 12B; to be 3 until the outer side of the side beam 61B passes through the boundary position “a” as well as until the inner side of the side beam 61A passes through the boundary position “a”; and to be 2 thereafter. In DOW0 state, the number of the recorded portions is to be 2 for an extremely short time while the boundary position “a” passes through between the inner side of the side beam 61A and the main beam 60.

In such a manner, the sum of the reflected light amounts by the side beams 61A and 61B has the highest level in DOW0 state in that the white track is recorded, despite of the recording direction. Also, in states between DOW0 state and that before DOW0 state by approximately one track, it has a second highest level, and the lowest level there before. Thus, by monitoring the sum of the reflected light amounts by the side beams 61A and 61B during recording, the present recording can be determined whether it is overwriting (DOW1) or the recording on a white portion (DOW0), during the recording.

More specifically, as is understood from FIGS. 12A and 12B, by detecting the level change from the level of the sum of the reflected light amounts of the side beams 61A and 61B when the number of the recorded portions neighboring to the side beams 61A and 61B is 3 to the level when the number of the recorded portions is 2, the recording state transition from DOW1 state to DOW0 state can be known.

That is, by detecting whether the sum of the reflected light amounts of the side beams 61A and 61B exceeds a predetermined threshold value or not, the present recoding can be determined whether it is in DOW0 state or in DOW1 state, so that the recording conditions can be changed on the basis of the determined result.

For example, about the detracking, when recording from outer radial side of the disk toward the inner radial side, if it is in DOW0 state, the recording conditions are established so that an offset is electrically applied to the tracking error signal for tracking in the inner radial direction. Also, when recording from outer radial side of the disk toward the inner radial side and overwriting at the start of the recording, i.e., in DOW1 state, the recording conditions are established so that an offset is not electrically applied to the tracking error signal at the start of the recording. Then, at a time when it is determined that, the recording conditions be changed to DOW0 state so that an offset is electrically applied to the tracking error signal for tracking in the inner radial direction. By doing so, when the L1 layer of the one side two-layered disk is recorded, the detracking generating during recording state transition from DOW1 state to DOW0 state can be prevented.

A method for determining a threshold value for determining whether the present recording is in DOW0 state or in DOW1 state will be described more specifically. As described above, the sum of the reflected light amounts of the side beams 61A and 61B changes stepwise corresponding to the number of the recorded tracks (recorded portions) neighboring to the side beams 61A and 61B. During the recording, as is already described with reference to FIGS. 12A and 12B, the number of the recorded portions neighboring to the side beams 61A and 61B is to be 2 to 4, and the sum of the reflected light amounts of the side beams 61A and 61B also has three-step values.

If including during reproducing, the sum of the reflected light amounts of the side beams 61A and 61B may have five-step values. That is, during reproducing, in a state in that the main beam 60 is located in a white portion, there are cases where portions on both sides of the side beams 61A and 61B are white so that the number of the neighboring recorded portions is 0, and where only one side of any one of the side beams 61A and 61B neighbors to the recorded portion so that the number of the neighboring recorded portions is 1. If the cases are included where during the reproducing, the number of the neighboring recorded portions is 0 and the number of the neighboring recorded portions is 1, the sum of the reflected light amounts of the side beams 61A and 61B has five-step values.

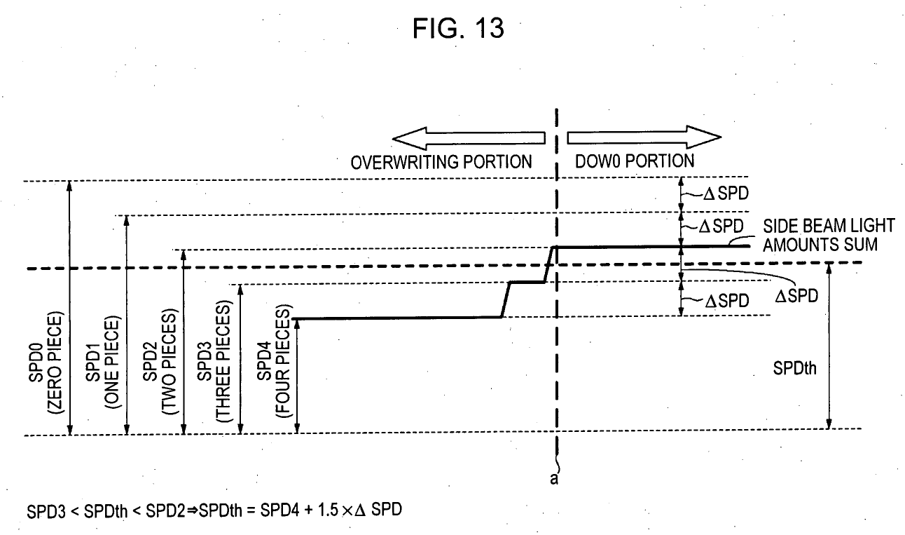

The level of the sum of the reflected light amounts of the side beams 61A and 61B is assumed to be SPDn (n=0 to 4) when the number of the recorded portions neighboring to the side beams 61A and 61B is to be n. FIG. 13 shows the relationship among example levels SPD0 to SPD4. The change ΔSPD in sum of the reflected light amounts of the recorded portions neighboring to the side beams 61A and 61B can be obtained by equation (3).
ΔSPD=(SPD0−SPD4)/4 (3)

On the other hand, as described above, during transition from DOW1 state to DOW0 state, the level SPD3 when the number of the recorded portions of the side beams 61A and 61B is 3 is changed to the level SPD2 when the number of the recorded portions is 2. Thus, if a threshold value for determining whether the present recording is in DOW0 state or in DOW1 state is to be a threshold value SPDₜₕ, the relationship between the threshold value SPDₜₕ, the level SPD2, and the level SPD3 is obtained from equation (4).
SPD3<SPDₜₕ<SPD2 (4)

From the equations (4) and (3), the threshold value SPDₜₕ can be established as equation (5), for example.
SPDₜₕ=SPD4+1.5×ΔSPD (5).

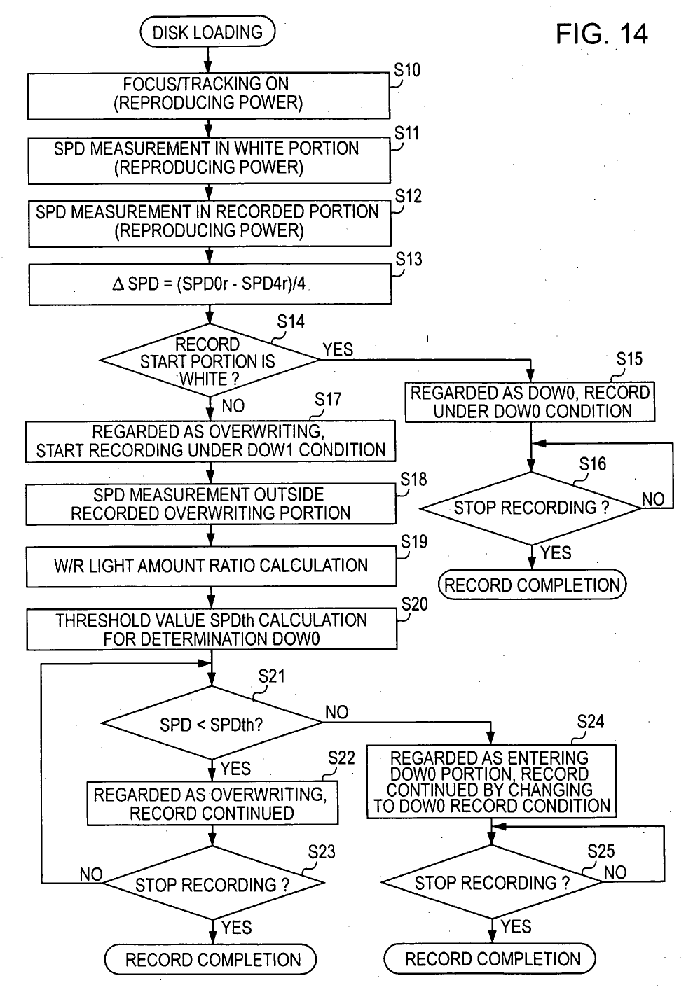

Then, a practical setting method of the threshold value SPDₜₕ will be described with reference to the flowchart of FIG. 14. In addition, various determinations and controls in the flowchart of FIG. 14 are executed by a microcomputer.

When the optical disk 10 is loaded in the optical disk drive 1, the laser light source 30 is activated by reproducing power so as to emit a laser beam. On the basis of the laser beam reflected from the optical disk 10, focus servo and tracking servo are performed (Step S10). The description below will be when recording from outer radial side of the optical disk 10 toward the inner radial side.

At next Step S11 and Step S12, the sums (SPDs) of reflected light amounts of the side beams 61A and 61B by the laser light with reproducing power in white portions and recorded portions of the optical disk 10 are measured. In the example in FIGS. 5 and 6 described above, the sum SPD of the reflected light amounts of the side beams 61A and 61B can be obtained by adding the outputs of the half-divided components E to H of the photo-detector 40. That is, the sum of the reflected light amounts SPD can be obtained from the following equation (6).
SPD=E+F+G+H (6)

The signal processing unit 25 obtains the sum of the reflected light amounts SPD on the basis of the output of the photo-detector 40 so as to feed it to the microcomputer 27. The processing order of Step S11 and Step S12 may be reversed.

For example, at Step S11, the optical pick-up 22 is moved so that the number of white portions neighboring to the side beams 61A and 61B of the optical disk 10 is 0, and the sum of the reflected light amounts SPD0r of the side beams 61A and 61B by the reproducing power is measured. Similarly, at Step S12, the optical pick-up 22 is moved so that the number of white portions neighboring to the side beams 61A and 61B of the optical disk 10 is 4, and the sum of the reflected light amounts SPD4r of the side beams 61A and 61B by the reproducing power is measured.

When the optical disk 10 is complying with the DVD-RW standard, after loading the optical disk 10 in the optical disk drive 1, the RMA is accessed at first so as to read out the recording management information stored in the RMA. During the reading the recording management information, the sum of the reflected light amounts of the recorded portions of the side beams 61A and 61B SPD4r can be measured at Step S12.

In the RMA, information is added every time when the optical disk 10 is rewritten, so that if the number of rewriting times is small, the RMA has a sufficient free space. Consequently, the sum of the reflected light amounts of the white portions SPD0r can be measured using the white space of the RMA at Step S11.

On the basis of the disk information stored in the lead-in area, the white and recorded portions of the optical disk 10 may also be accessed so as to measure the sums of the reflected light amounts SPD0r and SPD4r. Furthermore, depending on the information management format, the RMA may store positional information indicating the positions of the recorded and white portions of the data area, so that the sums of the reflected light amounts SPD0r and SPD4r may also be measured on the basis of the RMA information.

On the other hand, when the optical disk 10 is complying with the DVD+RW standard, after loading the optical disk 10 in the optical disk drive 1, the lead-in area is accessed at first. The lead-in area, as described above, stores the positional information indicating the positions of the recorded and white portions of the data area such as the number of initiation/completion sectors of the optical disk 10. On the basis of the information of the lead-in area, the sums of the reflected light amounts of the recorded and white portions of the data area SPD0r and SPD4r can be measured at Step S11 and Step S12.

When there is no recorded portion, the sum of the reflected light amounts can be measured after trial writing. In this case, it is necessary to record on the entire groups neighboring to the side beams 61A and 61B so that the number of recorded portions neighboring to the side beams 61A and 61B is to be 4.

After the sums of the reflected light amounts SPD0r and SPD4r are measured, at Step S13, the change in sum of the reflected light amounts of the recorded portions by the reproducing power ΔSPDr is obtained. The change in sum of the reflected light amounts ΔSPDr can be obtained from the following equation (7) on the basis of the equation (3).
ΔSPDr=(SPD0r−SPD4r)/4 (7)

At next Step S14, the record start portion is determined whether it is white or not. If the optical disk 10 to be recorded is white, for example, the lead-in area has no recorded signal. Thus, on the basis of the reproducing signal when the lead-in area is accessed after loading the optical disk 10 in the optical disk drive 1, the optical disk 10 can be determined whether it is white or not. If it is white, the record start portion is determined to be white.

If the record start portion is determined to be white at Step S14, the process proceeds to Step S15. At Step S15, it is assumed to record in DOW0 state so as to establish the recording conditions in DOW0 state. For example, the microcomputer 27 controls the signal processing unit 25 so as to apply a predetermined electrical offset to a tracking error signal for tracking in the inner radial direction.

When the recording conditions are set in DOW0 state at Step S15, the recording is continued thereafter under the recording conditions of DOW0 state until the record stopping is instructed via the host I/F 26 (Step S16).

On the other hand, if the record start portion is determined to be not white at Step S14, the process is shifted to Step S17. At Step S17, it is assumed to overwrite because the record start portion is recorded, so that the recording conditions are set in DOW1 state so as to start recording. For example, the microcomputer 27 controls the signal processing unit 25 so as not to apply an electrical offset to the tracking error signal on the basis of the determined results at Step S14. Then, the exiting power of the laser light source 30 is switched to the recording power so as to start recording under the recording conditions of DOW1 state.

Upon starting the record, during the overwriting, the sum of the reflected light amounts of the side beams 61A and 61B is measured (Step S18). As is understood from FIGS. 12A and 12B, in the overwriting (DOW1 state), the probability is very high in that the number of recorded portions neighboring to the side beams 61A and 61B is 4. Hence, the sum of the reflected light amounts to be measured at Step S18 is assumed to be the value when the number of recorded portions neighboring to the side beams 61A and 61B is 4. The sum of the reflected light amounts obtained at Step S18 is designated to be the sum of the reflected light amounts SPD4w. The reflected light amounts SPD4w is an average value during the recording.

At next Step S19, a light amount ratio α=SPD4w/SPD4r of the sum of the reflected light amounts SPD4w by the recording power to the sum of the reflected light amounts SPD4r by reproducing power is obtained.

At Step S20, a threshold value SPDth for determining whether the present recording is in DOW0 state or in DOW1 state is obtained. The threshold value SPDth can be calculated from the following equation (8) using the equation (3), the equation (7), and the light amount ratio α:
SPDₜₕ=α×(SPD4r+1.5×ΔSPDr) (8)

Then, during the recording, the sum of the reflected light amounts SPDw of the side beams 61A and 61B by the recording power is continuously measured, and it is compared with the threshold value SPDth obtained at Step S20 (Step S21). From the compared result, if the sum of the reflected light amounts SPDw does not exceed the threshold value SPDth, the process is shifted to Step S22, and the present recording is determined to be the overwriting on the recorded portions, so that under the present recording conditions, that is the recording conditions in DOW1 state established at Step S17, the recording is continued (Step S23).

On the other hand, as a compared result, if the sum of the reflected light amounts SPDw exceeds the threshold value SPDₜₕ, the process is shifted to Step S24, and the present recording is determined to enter a white portion, so that the recording conditions are changed to the conditions in DOW0 state so as to continue the recording (Step S25). For example, the microcomputer 27 controls the signal processing unit 25 so as to apply a predetermined electrical offset to the tracking error signal for tracking in the inner radial direction on the basis of the determination at Step S21.

As described above, the timing at which the sum of the reflected light amounts changes from the sum of the reflected light amounts SPD3w to the sum of the reflected light amounts SPD2w is different from the timing at which the practical recording state changes from DOW0 state to DOW1 state by the space between the side beams 61A and 61B. Since this difference is known, the timing in changing the recording conditions can be delayed in advance.

In the above-description, by detecting the change from the sum of the reflected light amounts SPD3w to the sum of the reflected light amounts SPD2w, the transition from DOW1 state to DOW0 state is determined so as to change the recording conditions. However, the invention is not limited to this, so that on the basis of the change from the sum of the reflected light amounts SPD4w to the sum of the reflected light amounts SPD3w, the recording conditions may be changed, for example. In this case, after a lapse of time corresponding to approximately one track since the change is detected, DOW1 state is changed to DOW0 state. Thus, this method is desirable for using in a case where the change in recording conditions requires some extent of time.

In such a manner, according to the embodiment, by monitoring changes in sum of the reflected light amounts of the side beams 61A and 61B, the transition of the recording state from DOW1 state to DOW0 state can be detected. The detracking generated when recording from the outer radial side of the disk toward the inner radial side is thereby prevented.

In the above-description, the recording condition established at Step S15, Step S17, and Step S24 is an electrical offset for the tracking error signal; however, the invention is not limited to this. For example, in the recording conditions such as recording power of laser light, a strategy, and servo setting, the optimum setting may be different in between DOW0 recording and DOW1 recording.

On the basis of the sum SPD of the reflected light amounts of the side beams 61A and 61B, the present recording is detected whether it is in DOW0 state or in DOW1 state so as to establish the recording conditions corresponding to detected results. For example, on the basis of the determinations at Step S14 and Step S21, the microcomputer 27 feeds control signals to the servo control unit 28 and the signal processing unit 25 for establishing the recording conditions corresponding to the present recording state.

The processing according to the flowchart of FIG. 14 described above may also be applied to the recording from the inner radial side of the optical disk 10 toward the outer radial side. However, when recording from the inner radial side of the optical disk 10 toward the outer radial side, as described earlier, even in DOW0 state, in the respective side beams 61A and 61B, the recording states of portions on both sides are the same. Thus, the detracking due to the difference between receiving light amounts of the two-divided element due to the recording state difference between the beam portions on both sides may not occur. Accordingly, when recording from the inner radial side of the optical disk 10 toward the outer radial side, the applications at Step S15 and Step S25 of a predetermined electrical offset to the tracking error signal are omitted.

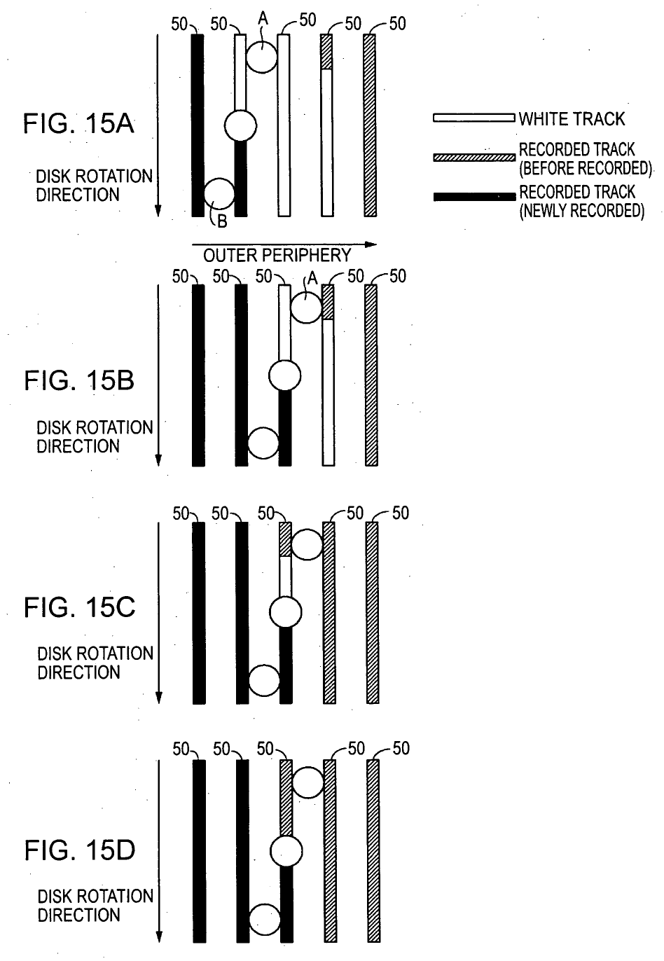

Next, a modification of the embodiment of the present invention will be described. According to the embodiment, the recording state shifting from DOW0 state to DOW1 state has been described; however, the present invention is not limited to this, so that the recording state shifting from DOW1 state to DOW0 state may also incorporate the invention. With reference to FIGS. 15A to 19, a recording state shifting from DOW1 state to DOW0 state according to the modification of the embodiment of the present invention will be described.

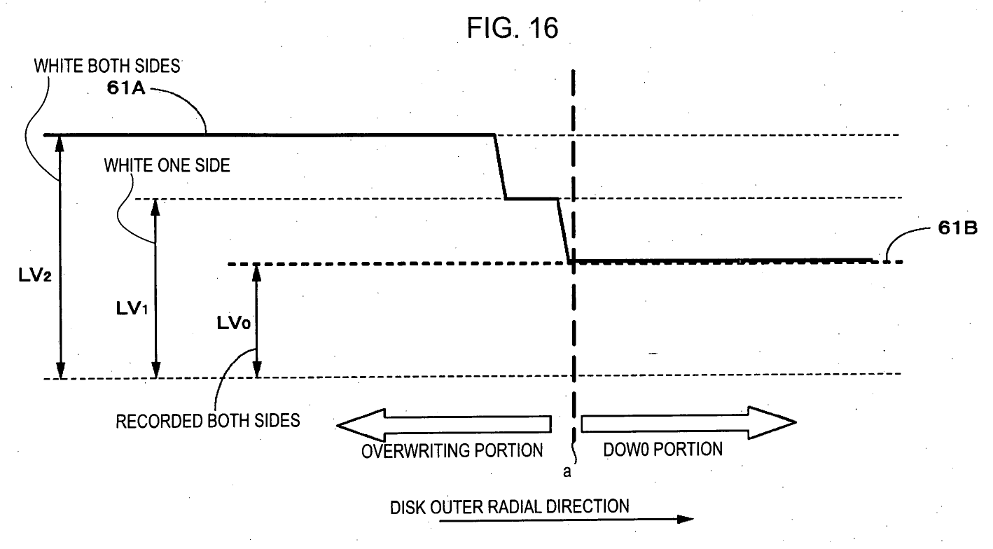

First, with reference to FIGS. 15A to 16, changes in reflected light amounts of the side beams 61A and 61B when recording from the inner radial side of the optical disk 10 toward the outer radial side will be described. In addition, designations of portions in FIGS. 15A to 16 are common to those in FIGS. 8A to 9 described above, so that the description thereof is omitted.

In an initial DOW0 state in that the main beam 60 is located in a white portion, as shown in FIG. 15A, portions on both sides of the side beam 61A preceding the main beam 60 are white while portions on both sides of the side beam 61B succeeding the main beam 60 are recorded. As the recording process proceeds, as shown in FIG. 15B, the outer radial side of the preceding side beam 61A reaches the recorded portion. When the recording process further proceeds beyond the state of FIG. 15C from that of FIG. 15B, the main beam 60 reaches the recorded portion so as to be in DOW1 state. The DOW0 recording state is maintained thereafter (FIG. 15D).

As shown in FIG. 16, the changes in reflected light amounts of the side beams 61A and 61B are reverse to those shown in FIG. 9. That is, since the initial recording is in DOW0 state, portions on both sides of the side beam 61A are white (see FIG. 15A) and the reflected light amount is at level LV₂. At a time when the outer radial side of the side beam 61A reaches the recorded portion (see FIG. 15B), the reflected light amount becomes level LV₁. After the optical disk 10 is rotated by one revolution from this state, and thereafter, the reflected light amount becomes level LV₀ (see FIGS. 15C and 15D).

On the other hand, since portions on both sides of the succeeding side beam 61B are typically recorded, the reflected light amount is at level LV₀.

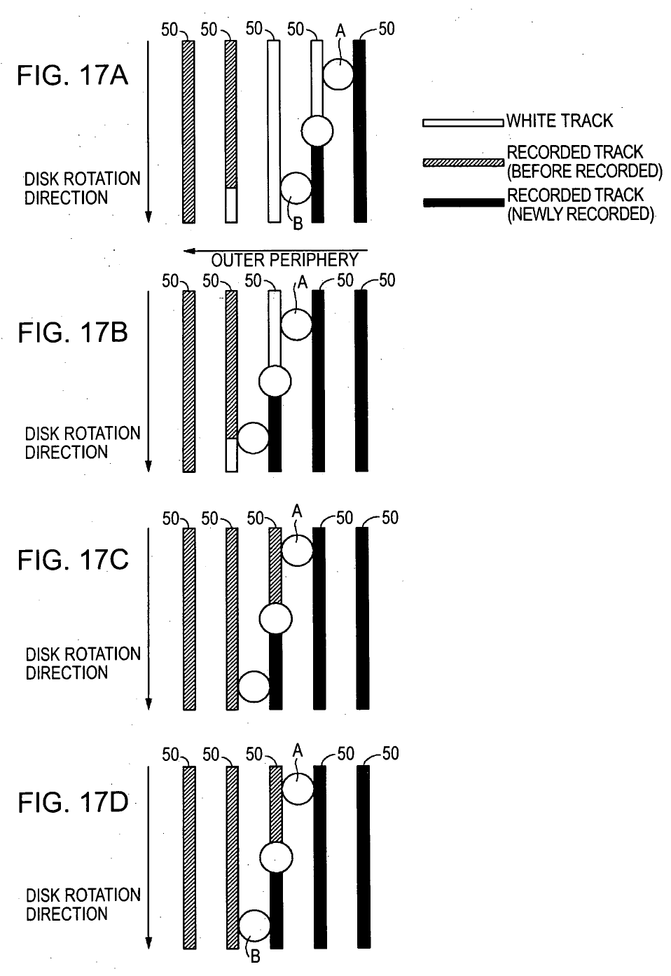

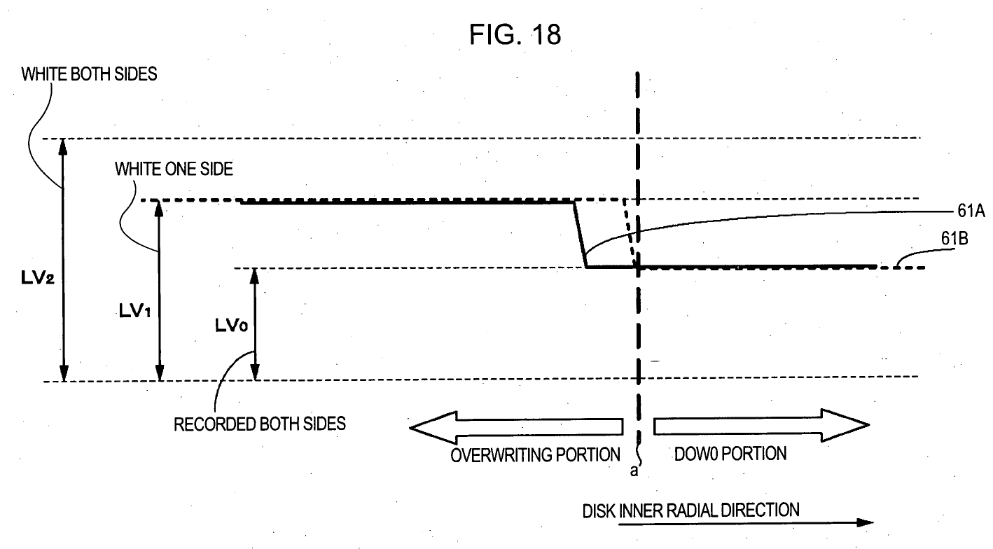

Then, with reference to FIGS. 17A to 18, changes in reflected light amounts of the side beams 61A and 61B when recording from the outer radial side of the optical disk 10 toward the inner radial side will be described. In addition, designations of portions in FIGS. 17A to 18 are common to those in FIGS. 8A to 9 described above, so that the description thereof is omitted.

As described above, when recording from the outer radial side of the optical disk 10 toward the inner radial side, the side beam 61A precedes the main beam 60 in the revolution direction of the disk 10 and succeeds the main beam 60 in the tracking direction. Also, the side beam 61B succeeds the main beam 60 in the revolution direction of the disk 10 and precedes the main beam 60 in the tracking direction. Therefore, in an initial DOW0 state in that the main beam 60 is located in a white portion, as shown in FIG. 17A, in both the side beams 61A and 61B, a portion on the outer radial side is recorded and a portion on the inner radial side is white.

As the recording process proceeds from the state of FIG. 17A, as shown in FIG. 17B, the inner radial side of the side beam 60B reaches the recorded portion. When the recording process further proceeds from this state, the main beam 60 reaches the recorded portion so as to move to DOW1 state from DOW0 state (FIG. 17C). The DOW1 recording state is maintained thereafter (FIG. 17D).

When recording from the outer radial side of the disk 10 toward the inner radial side, as shown in FIG. 18, the changes in reflected light amounts of the side beams 61A and 61B are also reverse to those shown in FIG. 11.

That is, since the initial recording is in DOW0 state, in the side beam 61A, a portion on the outer radial side is recorded and a portion on the inner radial side is white (see FIG. 17A), and the reflected light amount is at level LV₁ and becomes level LV₀ at a time when the inner radial side reaches the recorded portion. Then, slightly thereafter, the main beam 60 reaches the recorded portion so as to move to DOW1 state from DOW0 state (see FIG. 17C).

Also, in the side beam 61B, initially a portion on the outer radial side is recorded and a portion on the inner radial side is white (see FIG. 17A), and the reflected light amount is at level LV₁ and becomes level LV₀ at a time when the beam reaches the recorded portion (see FIG. 17B).

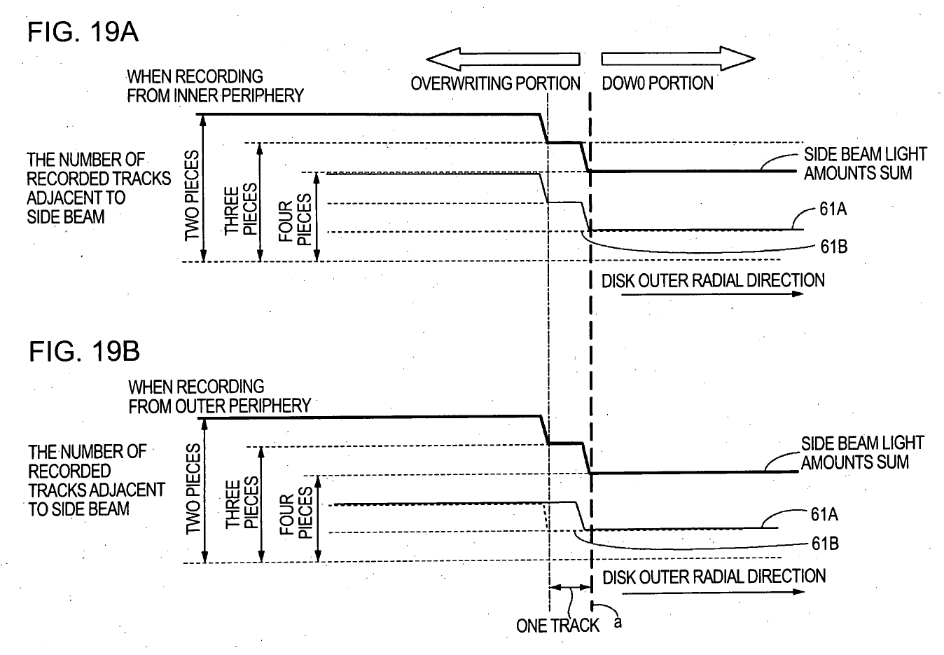

FIGS. 19A and 19B show changes in sum of the reflected light amounts of the side beams 61A and 61B. FIG. 19A shows the example when recording from the inner side toward the outer side while FIG. 19B shows the example when recording from the outer side toward the inner side. When the recording state moves from DOW0 state to DOW1 state in such a manner, in the same way as in the example of FIGS. 12A and 12B, the sum of the reflected light amounts changes in a predetermined manner at the boundary position “a”, i.e., in front and rear of DOW0. In this case, differently from the example of FIGS. 12A and 12B, after the sum of the reflected light amounts of the side beams 61A and 61B is reduced from level SPD3 to level SPD4, the recording state moves from DOW0 state to DOW1 state.

Therefore, during transition from DOW0 state to DOW1 state, a threshold value SPDth for determining whether the present recording is in DOW0 state or in DOW1 state is to be:
SPD3>SPDₜₕ>SPD4 (9),
the equation (10) can be established as follows:
SPDₜₕ=SPD4+0.5×ΔSPD (10).

The method according to the modification of the embodiment of the present invention may be combined with the method according to the embodiment of the present invention. For example, on the basis of the sums of the reflected light amounts of the side beams 61A and 61B in the state of the present recording, it can be determined that any of the method according to the modification of the embodiment of the present invention and the method according to the embodiment of the present invention be incorporated. If the sums of the reflected light amounts is at level SPD4, the method according to the embodiment of the present invention is applied, while the sums of the reflected light amounts is at level SPD2, the method according to the modification of the embodiment of the present invention is applied. Then, in the respective methods, if DOW state is changed, the applied method is also switched.

In the above, recording media incorporating the invention have been described as rewritable DVDs complying with DVD-RW standards and DVD+RW standards; however, the invention is not limited to these examples. That is, other than the rewritable DVDS, a rewritable CD (compact disc) such as a CDRW (compact disc-rewritable) and other recording media tracking by the DPP system such as a Blu-ray disk may incorporate the present invention.

Also, one-side two-layered disks have been described as the recording medium according to the embodiment; however, the invention is not limited to these examples. A single layered disk having one recording layer and a multiple-layered disk having three or more recording layers may incorporate the present invention.

Moreover, in the above-description, the side beam 61A preceding the main beam 60 in the revolution direction of the optical disk 10 is arranged on the outer radial side of the disk 10; however, the invention is not limited to the example. The reverse arrangement in that the side beam preceding the main beam 60 in the revolution direction of the disk 10 is arranged on the inner radial side of the disk 10 may easily incorporate the invention.

In this case, in DOW0 state recording on the white portion, the side beam 61A succeeds the main beam 60 in the revolution direction of the optical disk 10 while the side beam 61B succeeds the main beam 60 in the tracking direction.

Accordingly, when recording from the inner radial side of the optical disk 10 toward the outer radial side, although not shown, in both the side beams 61A and 61B, the inner radial side is recorded and the outer radial side is white, so that when an offset is not applied to the tracking, the main beam 60 is detracked in the inner radial side. Then, in recording DOW0 state, the recording conditions are established so as to apply an electrical offset to the tracking error signal for tracking in the outer radial side.

Similarly, when recording from the outer radial side of the optical disk 10 toward the inner radial side, in recording DOW0 state, although not shown, portions on both sides of the side beam 61A are recorded and portions on both sides of the side beam 61B are white, so that the application of the electric offset to the tracking error signal is not required.

In this case, during transition from DOW1 state to DOW0 state, the change in number of recorded portions neighboring to the side beams 61A and 61B is the same as that shown in FIG. 9. Also, during transition from DOW1 state to DOW0 state, the change in number of recorded portions neighboring to the side beams 61A and 61B is the same as that shown in FIG. 11. Hence, as described above with reference to FIGS. 12A and 12B, by detecting the change from the sum of the reflected light amounts SPD3w to the sum of the reflected light amounts SPD2w, the transition from DOW1 state to DOW0 state can be determined.

It should be understood by those skilled in the art that various modifications, combinations, sub-combinations and alterations may occur depending on design requirements and other factors insofar as they are within the scope of the appended claims or the equivalents thereof.

1. An optical disk recording apparatus, comprising:
beam emitting means for emitting a first beam for irradiating a track on an optical disk so as to record data and second and third beams for irradiating spaces between the track and tracks on both sides of the track, respectively;
light detecting means for detecting the first to third beams reflected from the optical disk;
tracking controlling means for controlling tracking of the first beam based on the reflected first to third beams detected by the light detecting means; and
determining means for determining whether the first beam records data on a white portion of the track or overwrites data on a recorded portion of the track based on changes in reflected light amounts of the second and third beams detected by the light detecting means.

2. The apparatus according to claim 1, wherein the determining means performs the determination based on the change in sum of the reflected light amounts of the second and third beams.

3. The apparatus according to claim 2, wherein the determining means determines that when the sum of the reflected light amounts exceeds a threshold value, the state of the first beam overwriting data on the recorded portion of the track is changed to the state recording data on the white portion of the track.

4. The apparatus according to claim 2, wherein the determining means determines that when the sum of the reflected light amounts is decreased smaller than a threshold value, the state of the first beam recording data on the white portion of the track is changed to the state overwriting data on the recorded portion of the track.

5. The apparatus according to claim 1, wherein
the second beam precedes the first beam in a revolution direction of the optical disk and is arranged on the outer radial side of the optical disk, and
the third beam succeeds the first beam in the revolution direction of the optical disk and is arranged on the inner radial side of the optical disk.

6. The apparatus according to claim 5, wherein when the recording is performed by the first beam from the outer radial side of the optical disk toward the inner radial side, if the determining means determines that the state of the first beam overwriting data on the recorded portion of the track is changed to the state recording data on the white portion of the track, the determining means controls the tracking controlling means so as to offset the tracking of the first beam in the inner radial direction of the optical disk.

7. The apparatus according to claim 1, wherein
the second beam succeeds the first beam in a revolution direction of the optical disk and is arranged on the inner radial side of the optical disk, and
the third beam precedes the first beam in the revolution direction of the optical disk and is arranged on the outer radial side of the optical disk.

8. The apparatus according to claim 7, wherein when the recording is performed by the first beam from the inner radial side of the optical disk toward the outer radial side, if the determining means determines that the state of the first beam overwriting data on the recorded portion of the track is changed to the state recording data on the white portion of the track, the determining means controls the tracking controlling means so as to offset the tracking of the first beam in the outer radial direction of the optical disk.

9. The apparatus according to claim 1, wherein the determining means changes recording conditions according to its determination.

10. The apparatus according to claim 1, wherein
the light detecting means includes a first light receiving unit divided into two sections along the track direction for receiving the first beam reflected from the optical disk, a second light receiving unit divided into two sections along the track direction for receiving the second beam reflected from the optical disk, and a third light receiving unit divided into two sections along the track direction for receiving the third beam reflected from the optical disk, and
the tracking controlling means controls the tracking of the first beam based on the difference between results respectively detected by the two-divided sections of the first light receiving unit, the difference between results respectively detected by the two-divided sections of the second light receiving unit, and the difference between results respectively detected by the two-divided sections of the third light receiving unit.

11. An optical disk recording method, comprising:
emitting a first beam for irradiating a track on an optical disk so as to record data and second and third beams for irradiating spaces between the track and tracks on both sides of the track, respectively;
detecting the first to third beams reflected from the optical disk;
controlling tracking of the first beam based on the reflected first to third beams; and
determining whether the first beam records data on a white portion of the track or overwrites data on a recorded portion of the track based on the changes in reflected light amounts of the second and third beams.

12. A recording control program for allowing a computer to execute an optical disk recording method, the optical disk recording method comprising:
emitting a first beam for irradiating a track on an optical disk so as to record data and second and third beams for irradiating spaces between the track and tracks on both sides of the track, respectively;
detecting the first to third beams reflected from the optical disk;
controlling tracking of the first beam based on results of the reflected first to third beams; and
determining whether the first beam records data on a white portion of the track or overwrites data on a recorded portion of the track based on changes in reflected light amounts of the second and third beams.

13. An optical disk recording apparatus, comprising:
a beam emitting unit operable to emit a first beam for irradiating a track on an optical disk so as to record data and second and third beams for irradiating spaces between the track and tracks on both sides of the track, respectively;
a light detection mechanism operable to detect the first to third beams reflected from the optical disk;
a tracking controller operable to control tracking of the first beam on the basis of results of the reflected first to third beams detected by the light detection mechanism; and
a determination unit operable to determine whether the first beam records data on a white portion of the track or overwrites data on a recorded portion of the track based on changes in reflected light amounts of the second and third beams detected by the light detection mechanism.
